(19) United States
(12) Patent Application Publication
(10) Pub. No.: US 2023/0223186 A1
(43) Pub. Date: Jul. 13, 2023

(54) MAGNETIC DEVICE AND ELECTRONIC DEVICE WITH SAME

(71) Applicant: Delta Electronics, Inc., Taoyuan City (TW)

(72) Inventors: Da Jin, Shanghai (CN); Yahong Xiong, Shanghai (CN); Yang Leng, Shanghai (CN); Yankai Liu, Shanghai (CN); Zhongwang Yang, Shanghai (CN)

(21) Appl. No.: 18/092,846

(22) Filed: Jan. 3, 2023

(30) Foreign Application Priority Data
Jan. 13, 2022 (CN) 202210037690.2

(51) Int. Cl. H01F 27/30; H01F 27/26; H01F 3/14

(52) U.S. Cl. CPC H01F 27/306; H01F 27/263; H01F 3/14

(57) ABSTRACT

A magnetic device includes a magnetic core assembly and a winding assembly. The magnetic core assembly includes a first outer magnetic leg, a second outer magnetic leg, a first inner magnetic leg group and a second inner magnetic leg group. A first channel is formed between the first inner magnetic leg group and the first outer magnetic leg. A second channel is formed between the second inner magnetic leg group and the first inner magnetic leg group. A third channel is formed between the second inner magnetic leg group and the second outer magnetic leg. The winding assembly includes four coupled windings. The first terminals of the four coupled windings are located near a first lateral side of the magnetic core assembly. The second terminals of the four coupled windings are located near a second lateral side of the magnetic core assembly.

### CROSS-REFERENCE TO RELATED APPLICATION

This application claims priority to China Patent Application No. 202210037690.2, filed on Jan. 13, 2022, the entire contents of which are incorporated herein by reference for all purposes.

### FIELD OF THE INVENTION

The present disclosure relates to a magnetic device, and more particularly to a magnetic device for an electronic device.

### BACKGROUND OF THE INVENTION

With the advancement of Internet, cloud computing technologies, electric vehicle technologies, industrial automation technologies and associated technologies, the demands for electric power gradually increase. In other words, the demands for power sources also increased. Consequently, the electronic device has to be developed toward high power density and high efficiency. In order to meet the power requirements of high efficiency and high power density, the current industry practice is to increase the bus voltage in the electronic device (e.g., a power conversion module) from 12V to 48V. Consequently, the current loss on the bus and the cost of the bus are reduced. For achieving the purpose of power conversion, a power conversion module with two stage converters (e.g., a fixed-ratio converter and a buck converter) is employed to increase the bus voltage from 12V to 48V. However, the efficiency of the power conversion module with two stage converters is low, and the applications thereof are limited.

Therefore, there is a need of providing an improved magnetic device and an electronic device with the magnetic device in order to overcome the drawbacks of the conventional technologies.

### SUMMARY OF THE INVENTION

An object of the present disclosure is to provide a magnetic device with small volume, high efficiency and wide application.

Another object of the present disclosure is to provide an electronic device with the magnetic device.

In accordance with an aspect of the present disclosure, a magnetic device is provided. The magnetic device includes a magnetic core assembly and a winding assembly. The magnetic core assembly includes a first magnetic cover, a second magnetic cover, a first outer magnetic leg, a second outer magnetic leg, a first inner magnetic leg group and a second inner magnetic leg group. The first magnetic cover and the second magnetic cover are opposed to each other. The first outer magnetic leg is disposed between a first end of the first magnetic cover and a first end of the second magnetic cover. The second outer magnetic leg is disposed between a second end of the first magnetic cover and a second end of the second magnetic cover. The first inner magnetic leg group is disposed between the first magnetic cover and the second magnetic cover, and between the first outer magnetic leg and the second outer magnetic leg, and located beside the first outer magnetic leg. The second inner magnetic leg group is disposed between the first magnetic cover and the second magnetic cover, and between the first outer magnetic leg and the second outer magnetic leg, and located beside the second outer magnetic leg. A first channel is formed between the first inner magnetic leg group and the first outer magnetic leg. A second channel is formed between the second inner magnetic leg group and the first inner magnetic leg group. A third channel is formed between the second inner magnetic leg group and the second outer magnetic leg. The winding assembly includes four coupled windings. The four coupled windings include four first terminals and four second terminals. A first one of the four first terminals of the four coupled windings is located near a first lateral side of the magnetic core assembly and the first channel. A second one of the four first terminals of the four coupled windings is located near the first lateral side of the magnetic core assembly and the third channel. The other two of the four first terminals of the four coupled windings are located near the first lateral side of the magnetic core assembly and the second channel. A first one of the four second terminals of the four coupled windings is located near a second lateral side of the magnetic core assembly and the first channel. A second one of the four second terminals of the four coupled windings is located near the second lateral side of the magnetic core assembly and the third channel. The other two of the four second terminals of the four coupled windings are located near the second lateral side of the magnetic core assembly and the second channel.

In accordance with an aspect of the present disclosure, an electronic device is provided. The electronic device includes a circuit board, the magnetic device and at least one switch. The circuit board includes a first surface, a second surface and a plurality of openings. The plurality of openings run through the circuit board. The magnetic device has a structure as described above. The four coupled windings are disposed in the circuit board. The first magnetic cover is disposed on the first surface of the circuit board. The second magnetic cover is disposed on the second surface of the circuit board. The first outer magnetic leg, the second outer magnetic leg, the first inner magnetic leg group and the second inner magnetic leg group are penetrated through the corresponding one of the plurality of openings, respectively. The at least one switch is electrically connected with the magnetic device through at least one trace in the circuit board.

The present disclosure provides the power conversion module. The magnetic core assembly and the winding assembly in the magnetic device of the power conversion module are specially designed. Consequently, the voltage reduction function of the transformer is achieved, and the multi-phase output inductor with large inductance is obtained. That is, the power conversion module with the single-stage converter can achieve the voltage reduction function and the filtering function. In comparison with the conventional power conversion module with two stage converters, the magnetic device of the power conversion module of the present disclosure has reduced volume and increased integration. Consequently, the output ripple is low, the volume is small, the efficiency is high, and the application is expanded.

The above contents of the present disclosure will become more readily apparent to those ordinarily skilled in the art after reviewing the following detailed description and accompanying drawings, in which:

### BRIEF DESCRIPTION OF THE DRAWINGS

FIG. 1A is a schematic perspective view illustrating a power conversion module according to a first embodiment of the present disclosure;

FIG. 1B is a schematic perspective view illustrating the power conversion module as shown in FIG. 1A and taken along another viewpoint;

FIG. 1C is a schematic exploded view illustrating the power conversion module as shown in FIG. 1A;

FIG. 2 is a schematic exploded view illustrating a magnetic core assembly of the power conversion module as shown in FIG. 1A;

FIG. 3 is a schematic circuit diagram illustrating the circuitry topology of the power conversion module as shown in FIG. 1A;

FIG. 4 is a schematic timing waveform diagram illustrating associated voltage signals of the power conversion module as shown in FIG. 1A;

FIG. 5 schematically illustrates the magnetic core assembly and the winding assembly in the magnetic device of the power conversion module as shown in FIG. 1A, in which the first magnetic cover is not shown;

FIG. 6A is a schematic cross-sectional view illustrating the magnetic device of the power conversion module as shown in FIG. 1A and taken along the line A-A′;

FIG. 6B is a schematic cross-sectional view illustrating the magnetic device of the power conversion module as shown in FIG. 1A and taken along the line B-B′;

FIG. 7 schematically illustrates the magnetic core assembly and the winding assembly in the magnetic device of a power conversion module according to a second embodiment of the present disclosure, in which the first magnetic cover is not shown;

FIG. 8 schematically illustrates the magnetic core assembly and the winding assembly in the magnetic device of a power conversion module according to a third embodiment of the present disclosure, in which the first magnetic cover is not shown;

FIG. 9A is a schematic perspective view illustrating a power conversion module according to a fourth embodiment of the present disclosure;

FIG. 9B is a schematic perspective view illustrating the power conversion module as shown in FIG. 9A and taken along another viewpoint;

FIG. 10 is a schematic circuit diagram illustrating the circuitry topology of the power conversion module as shown in FIG. 9A;

FIG. 11 is a schematic timing waveform diagram illustrating associated voltage signals of the power conversion module as shown in FIG. 9A;

FIG. 12 schematically illustrates the magnetic core assembly and the winding assembly in the magnetic device of the power conversion module as shown in FIG. 9A, in which the first magnetic cover is not shown;

FIG. 13 is a schematic perspective view illustrating a power conversion module according to a fifth embodiment of the present disclosure;

FIG. 14 schematically illustrates the magnetic core assembly and the winding assembly in the magnetic device of the power conversion module as shown in FIG. 13, in which the first magnetic cover is not shown;

FIG. 15 is a schematic perspective view illustrating a power conversion module according to a sixth embodiment of the present disclosure; and

FIG. 16 is a schematic circuit diagram illustrating the circuitry topology of the power conversion module as shown in FIG. 15.

### DETAILED DESCRIPTION OF THE EMBODIMENTS

The present disclosure will now be described more specifically with reference to the following embodiments. It is to be noted that the following descriptions of embodiments of this invention are presented herein for purpose of illustration and description only. It is not intended to be exhaustive or to be limited to the precise form disclosed.

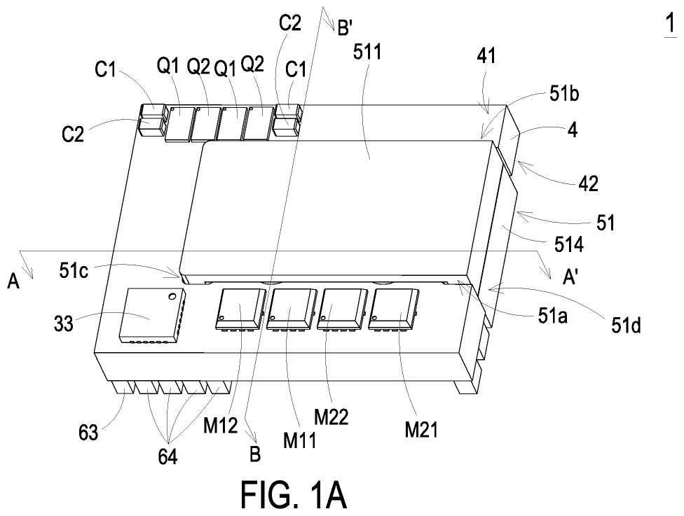

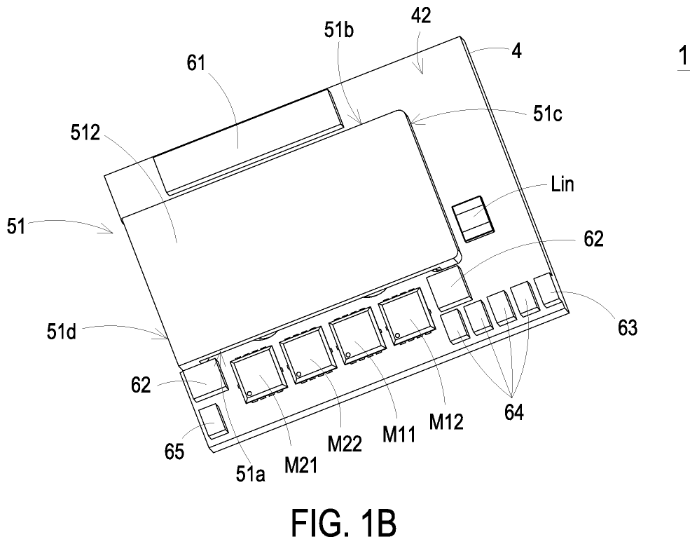

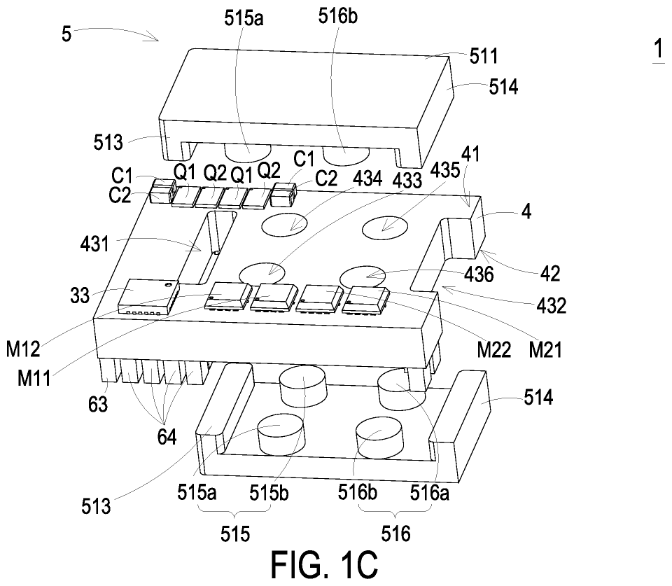

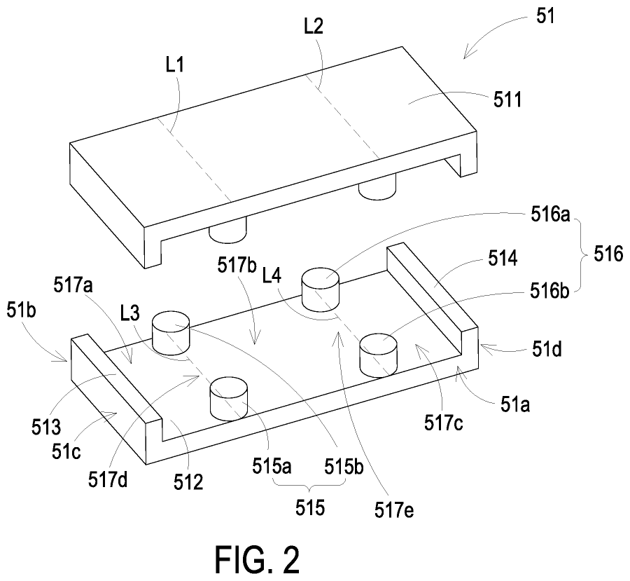

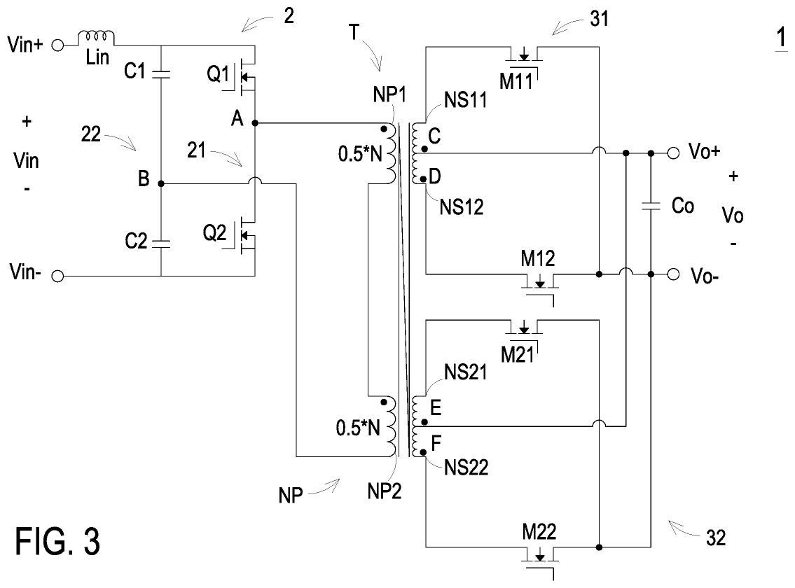

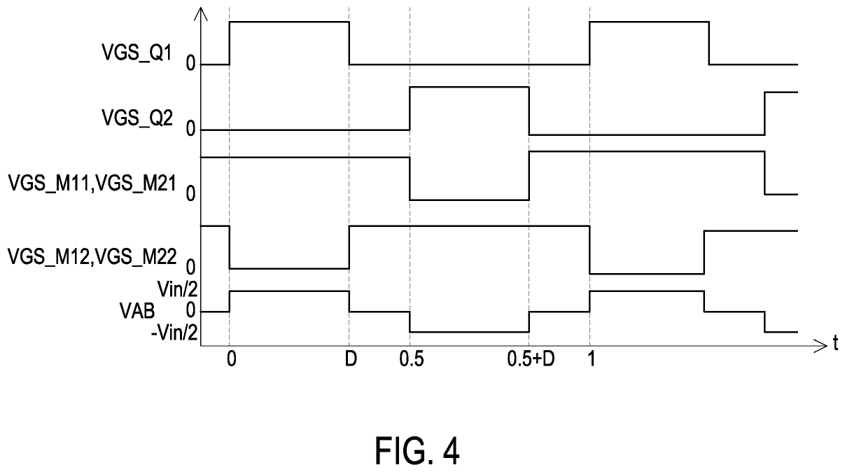

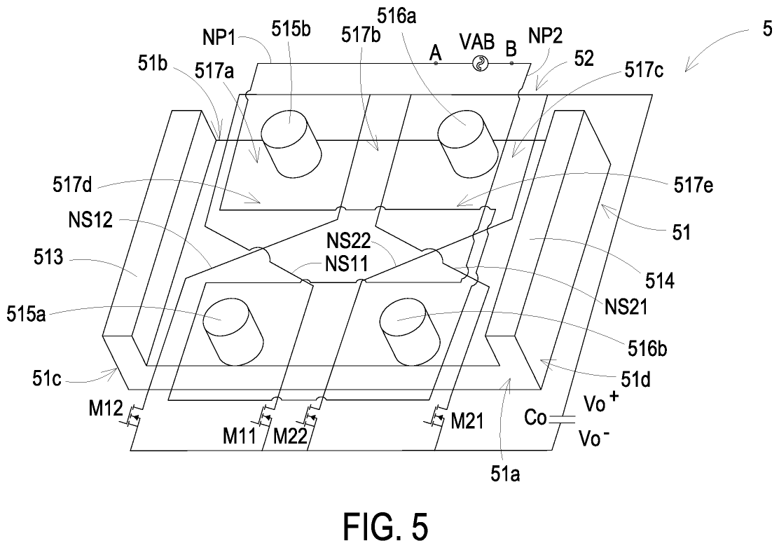

FIG. 1A is a schematic perspective view illustrating a power conversion module according to a first embodiment of the present disclosure. FIG. 1B is a schematic perspective view illustrating the power conversion module as shown in FIG. 1A and taken along another viewpoint. FIG. 1C is a schematic exploded view illustrating the power conversion module as shown in FIG. 1A. FIG. 2 is a schematic exploded view illustrating a magnetic core assembly of the power conversion module as shown in FIG. 1A. FIG. 3 is a schematic circuit diagram illustrating the circuitry topology of the power conversion module as shown in FIG. 1A. FIG. 4 is a schematic timing waveform diagram illustrating associated voltage signals of the power conversion module as shown in FIG. 1A. FIG. 5 schematically illustrates the magnetic core assembly and the winding assembly in the magnetic device of the power conversion module as shown in FIG. 1A, in which the first magnetic cover is not shown.

The present disclosure provides an electronic device 1. As shown in FIG. 3, the electronic device 1 includes an input positive terminal Vin+, an input negative terminal Vin−, an output positive terminal Vo+, an output negative terminal Vo−, a switching circuit 2, a magnetic device (e.g., a transformer T), a first rectifying circuit 31, a second rectifying circuit 32 and an output capacitor Co. Preferably but not exclusively, the electronic device 1 is a power conversion module. In this embodiment, the power conversion module 1 is an isolation type power conversion module, and the input negative terminal Vin− and the output negative terminal Vo− are not directly connected with each other. Alternatively, the power conversion module 1 can be a non-isolation type power conversion module, and the input negative terminal Vin− and the output negative terminal Vo− are directly connected with each other.

The switching circuit 2 includes an input inductor Lin, a switch bridge arm 21 and a capacitor bridge arm 22. The first terminal of the input inductor Lin is electrically connected with the input positive terminal Vin+. The switch bridge arm 21 and the capacitor bridge arm 22 are collaboratively formed as a half-bridge circuit. The switch bridge arm 21 is electrically connected between the second terminal of the input inductor Lin and the input negative terminal Vin−. The switch bridge arm 21 includes an upper switch Q1 and a lower switch Q2. The upper switch Q1 and the lower switch Q2 are connected in series and connected with a midpoint A of the switch bridge arm 21. Preferably but not exclusively, the upper switch Q1 and the lower switch Q2 are MOSFET switches, SiC switches or GaN switches. The capacitor bridge arm 22 is electrically connected between the second terminal of the input inductor Lin and the input negative terminal Vin−. The capacitor bridge arm 22 and the switch bridge arm 21 are connected with each other in parallel. The capacitor bridge arm 22 includes a first capacitor C1 and a second capacitor C2. The first capacitor C1 and the second capacitor C2 are connected in series. Moreover, the first capacitor C1 and the second capacitor C2 are connected with a midpoint B of the capacitor bridge arm 22.

The transformer T includes a primary winding assembly NP, a first secondary winding NS11, a second secondary winding NS12, a third secondary winding NS21 and a fourth secondary winding NS22. The primary winding assembly NP includes a first primary winding NP1 and a second primary winding NP2, which are serially connected between the midpoint A of the switch bridge arm 21 and the midpoint B of the capacitor bridge arm 22. The first terminal of the first primary winding NP1 (i.e., the first terminal of the primary winding NP) is electrically connected with the midpoint A of the switch bridge arm 21. The second terminal of the first primary winding NP1 is connected with the first terminal of the second primary winding NP2. The second terminal of the second primary winding NP2 (i.e., the second terminal of the primary winding assembly NP) is electrically connected with the midpoint B of the capacitor bridge arm 22. The first terminal of the first primary winding NP1 and the first terminal of the second primary winding NP2 are common-polarity terminals (i.e., dotted terminals). That is, the polarity of the first terminal of the first primary winding NP1 and the polarity of the first terminal of the second primary winding NP2 are identical. The second terminal of the first primary winding NP1 and the second terminal of the second primary winding NP2 are common-polarity terminals (i.e., undotted terminals). That is, the polarity of the second terminal of the first primary winding NP1 and the polarity of the second terminal of the second primary winding NP2 are identical. The polarity of the second terminal of the first primary winding NP1 and the polarity of the first terminal of the second primary winding NP2 are opposite. The first primary winding NP1, the second primary winding NP2 and the switching circuit 2 are collaboratively formed as a primary circuit of the power conversion module 1.

In an embodiment, the primary winding assembly NP has N turns, wherein N is a multiple of the number of the primary windings of the primary winding assembly NP. Moreover, the first primary winding NP1 has 0.5N turns, and the second primary winding NP2 has 0.5N turns. For example, in case that the primary winding assembly NP includes 2 primary windings (i.e., the first primary winding NP1 and the second primary winding NP2), N is a multiple of 2.

The first secondary winding NS11 and the second secondary winding NS12 are connected in series. The first secondary winding NS11 and the second secondary winding NS12 are magnetically coupled with the first primary winding NP1. The second terminal of the first secondary winding NS11 and the second terminal of the second secondary winding NS12 are electrically connected with each other. Moreover, the second terminal of the first secondary winding NS11 and the second terminal of the second secondary winding NS12 are electrically connected with the output positive terminal Vo+. The polarity of the second terminal of the first secondary winding NS11 and the polarity of the second terminal of the second secondary winding NS12 are opposite. The polarity of the first terminal of the first secondary winding NS11 and the polarity of the second terminal of the second secondary winding NS12 are opposite to the polarity of the first terminal (i.e., the dotted terminal) of the first primary winding NP1. The polarity of the second terminal of the first secondary winding NS11 and the polarity of the first terminal of the second secondary winding NS12 are identical to the polarity of the first terminal (i.e., the dotted terminal) of the first primary winding NP1. In an embodiment, each of the first secondary winding NS11 and the second secondary winding NS12 has one turn.

The first rectifying circuit 31 includes a first rectifying switch M11 and a second rectifying switch M12. The drain terminal of the first rectifying switch M11 is electrically connected with the first terminal of the first secondary winding NS11. The drain terminal of the second rectifying switch M12 is electrically connected with the first terminal of the second secondary winding NS12. The source terminal of the first rectifying switch M11 and the source terminal of the second rectifying switch M12 are connected with each other. Moreover, the source terminal of the first rectifying switch M11 and the source terminal of the second rectifying switch M12 are electrically connected with the output negative terminal Vo−. The first secondary winding NS11, the second secondary winding NS12 and the first rectifying circuit 31 are collaboratively formed as a first secondary circuit of the power conversion module 1.

The third secondary winding NS21 and the fourth secondary winding NS22 are connected in series. The third secondary winding NS21 and the fourth secondary winding NS22 are magnetically coupled with the second primary winding NP2. The second terminal of the third secondary winding NS21 and the second terminal of the fourth secondary winding NS22 are electrically connected with each other. Moreover, the second terminal of the third secondary winding NS21 and the second terminal of the fourth secondary winding NS22 are electrically connected with the output positive terminal Vo+. The polarity of the second terminal of the third secondary winding NS21 and the polarity of the second terminal of the fourth secondary winding NS22 are opposite. The polarity of the first terminal of the third secondary winding NS21 and the polarity of the second terminal of the fourth secondary winding NS22 are opposite to the polarity of the first terminal (i.e., the dotted terminal) of the second primary winding NP2. The polarity of the second terminal of the third secondary winding NS21 and the polarity of the first terminal of the fourth secondary winding NS22 are identical to the polarity of the first terminal (i.e., the dotted terminal) of the second primary winding NP2. In an embodiment, each of the third secondary winding NS21 and the fourth secondary winding NS22 has one turn.

The second rectifying circuit 32 includes a third rectifying switch M21 and a fourth rectifying switch M22. The drain terminal of the third rectifying switch M21 is electrically connected with the first terminal of the third secondary winding NS21. The drain terminal of the fourth rectifying switch M22 is electrically connected with the first terminal of the fourth secondary winding NS22. The source terminal of the third rectifying switch M21 and the source terminal of the fourth rectifying switch M22 are connected with each other. Moreover, the source terminal of the third rectifying switch M21 and the source terminal of the fourth rectifying switch M22 are electrically connected with the output negative terminal Vo−. The third secondary winding NS21, the fourth secondary winding NS22 and the second rectifying circuit 32 are collaboratively formed as a second secondary circuit of the power conversion module 1.

Preferably but not exclusively, the first rectifying switch M11, the second rectifying switch M12, the third rectifying switch M21 and the fourth rectifying switch M22 are MOSFET switches, SiC switches, GaN switches or diode switches. The two terminals of the output capacitor Co are electrically connected with the output positive terminal Vo+ and the output negative terminal Vo−, respectively.

In an embodiment, the power conversion module 1 further includes a plurality of driving circuits (not shown) and a control circuit 33. Preferably, the number of the driving circuits is equal to the number of the switches. For example, the power conversion module 1 includes six driving circuits. The six driving circuits are electrically connected with the upper switch Q1, the lower switch Q2, the first rectifying switch M11, the second rectifying switch M12, the third rectifying switch M21 and the fourth rectifying switch M22, respectively. The control circuit 33 is electrically connected with the six driving circuits. The control circuit 33 generates six PWM signals. The driving circuit generates the driving signal to drive the corresponding switch according to each PWM signal. The on/off states of the switches are controlled according to the corresponding driving signals. Consequently, the input voltage Vin is decreased to the output voltage Vo. The operation of the power conversion module 1 will be described as follows by referring to the waveform diagram of the driving signals for driving the corresponding switches.

In FIG. 4, VGS_Q1 denotes the gate-source voltage of the upper switch Q1, VGS_Q2 denotes the gate-source voltage of the lower switch Q2, VGS_M11 denotes the gate-source voltage of the first rectifying switch M11, VGS_M12 denotes the gate-source voltage of the second rectifying switch M12, VGS_M21 denotes the gate-source voltage of the third rectifying switch M21, and VGS_M22 denotes the gate-source voltage of the fourth rectifying switch M22. Moreover, VAB is the voltage between the midpoint A of the switch bridge arm 21 and the midpoint B of the capacitor bridge arm 22. That is, VAB is the terminal voltage between the first terminal of the first primary winding NP1 and the second terminal of the second primary winding NP2.

Please refer to FIG. 4 again. The upper switch Q1 receives a first driving signal. The waveform of the first driving signal matches the gate-source voltage VGS_Q1 of the upper switch Q1. The lower switch Q2 receives a second driving signal. The waveform of the second driving signal matches the gate-source voltage VGS_Q2 of the lower switch Q2. The duty cycle of the first driving signal and the duty cycle of the second driving signal are equal. The phase difference between the first driving signal and the second driving signal is 180 degrees.

Each of the first rectifying switch M11 and the third rectifying switch M21 receives a third driving signal. The first rectifying switch M11 and the third rectifying switch M21 are controlled to be turned on and turned off synchronously according to the third driving signal. The waveform of the third driving signal matches the gate-source voltage VGS_M11 of the first rectifying switch M11 and the gate-source voltage VGS_M21 of the third rectifying switch M21. Consequently, the frequency and the phase of the terminal voltage across the two terminals of the first secondary winding NS11 and the frequency and the phase of the terminal voltage across the two terminals of the third secondary winding NS21 are identical. The third driving signal and the second driving signal are complementary to each other.

Each of the second rectifying switch M12 and the fourth rectifying switch M22 receives a fourth driving signal. The second rectifying switch M12 and the fourth rectifying switch M22 are controlled to be turned on and turned off synchronously according to the fourth driving signal. The waveform of the fourth driving signal matches the gate-source voltage VGS_M12 of the second rectifying switch M12 and the gate-source voltage VGS_M22 of the fourth rectifying switch M22. Consequently, the frequency and the phase of the terminal voltage across the two terminals of the second secondary winding NS12 and the frequency and the phase of the terminal voltage across the two terminals of the fourth secondary winding NS22 are identical. The fourth driving signal and the first driving signal are complementary to each other.

Please refer to FIGS. 3 and 4. In an embodiment, the voltage between the midpoint A of the switch bridge arm 21 and the midpoint B of the capacitor bridge arm 22 is a three-level AC voltage. That is, the terminal voltage VAB has three voltage levels, including the positive input voltage (+Vin/2), 0 and the negative input voltage (−Vin/2). In case that the duty cycle D of each of the first driving signal and the second driving signal is close to 50%, there is almost no time interval corresponding to the zero voltage VAB. That is, the voltage VAB is zero in the dead time between the first driving signal and the second driving signal.

In another embodiment, the first capacitor C1 and the second capacitor C2 of the capacitor bridge arm 22 are replaced by switches. Under this circumstance, the switching circuit 2 includes two switch bridge arms. The methods for driving the switches of the two switch bridge arms are not restricted as long as the voltage VAB has three voltage levels including the positive input voltage (+Vin/2), 0 and the negative input voltage (−Vin/2). In another embodiment, a blocking capacitor is disposed between the midpoint A of the switch bridge arm 21 and the midpoint B of the capacitor bridge arm 22, or a current-sharing function is provided. Consequently, the DC current will not flow through the region between the midpoint A of the switch bridge arm 21 and the midpoint B of the capacitor bridge arm 22.

Please refer to FIGS. 1A, 1B, 1C, 2 and 3. The power conversion module 1 is disposed on the system board (not shown). The power conversion module 1 includes a circuit board 4, a magnetic device 5, the upper switch Q1, the lower switch Q2, the first capacitor C1, the second capacitor C2, and a plurality of rectifying switches M11, M12, M21, M22.

The circuit board 4 includes a first surface 41, a second surface 42, a first opening 431, a second opening 432, a third opening 433, a fourth opening 434, a fifth opening 435 and a sixth opening 436. The first surface 41 and the second surface 42 are opposed to each other. Preferably but not exclusively, the first opening 431 and the second opening 432 are elongated openings. In this embodiment, the second opening 432 is concavely formed in a lateral wall of the circuit board 4. Preferably but not exclusively, the third opening 433, the fourth opening 434, the fifth opening 435 and the sixth opening 436 are circular openings. The first opening 431, the second opening 432, the third opening 433, the fourth opening 434, the fifth opening 435 and the sixth opening 436 run through the circuit board 4. The third opening 433, the fourth opening 434, the fifth opening 435 and the sixth opening 436 are disposed between the first opening 431 and the second opening 432. The third opening 433 is disposed between the sixth opening 436 and the first opening 431. The fourth opening 434 is disposed between the fifth opening 435 and the first opening 431. The fifth opening 435 is disposed between the fourth opening 434 and the second opening 432. The sixth opening 436 is disposed between the third opening 433 and the second opening 432. The shortest distance between the third opening 433 and the first opening 431 is equal to the shortest distance between the fourth opening 434 and the first opening 431. The shortest distance between the fifth opening 435 and the second opening 432 is equal to the shortest distance between the sixth opening 436 and the second opening 432.

The magnetic device 5 is used as the transformer T as shown in FIG. 3. In an embodiment, the magnetic device 5 includes a magnetic core assembly 51 and a winding assembly 52 (see FIG. 5). The winding assembly 52 is disposed in the circuit board 4. The winding method of the winding assembly 52 will be described in FIG. 5. As shown in FIGS. 1C and 2, the magnetic core assembly 51 includes a first lateral side 51a, a second lateral side 51b, a third lateral side 51c, a fourth lateral side 51d, a first magnetic cover 511, a second magnetic cover 512, a first outer magnetic leg 513, a second outer magnetic leg 514, a first inner magnetic leg group 515 and a second inner magnetic leg group 516.

The first lateral side 51a and the second lateral side 51b are opposed to each other. The third lateral side 51c and the fourth lateral side 51d are opposed to each other. Moreover, the third lateral side 51c and the fourth lateral side 51d are disposed between the first lateral side 51a and the second lateral side 51b.

The first magnetic cover 511 is disposed on the first surface 41 of the circuit board 4. The second magnetic cover 512 is disposed on the second surface 42 of the circuit board 4. Moreover, the second magnetic cover 512 and the first magnetic cover 511 are opposed to each other. In an embodiment, the first magnetic cover 511 and the second magnetic cover 512 are fixed on the circuit board 4.

The first outer magnetic leg 513 is disposed between a first end of the first magnetic cover 511 and a first end of the second magnetic cover 512. The outer side of the first outer magnetic leg 513 away from the second outer magnetic leg 514 is the third lateral side 51c of the magnetic core assembly 51. Moreover, the first outer magnetic leg 513 is penetrated through the first opening 431 of the circuit board 4. As shown in FIGS. 1C and 2, the first outer magnetic leg 513 includes two sub-legs. One sub-leg of the first outer magnetic leg 513 is connected with the first magnetic cover 511. The other sub-leg of the first outer magnetic leg 513 is connected with the second magnetic cover 512. In another embodiment, the first outer magnetic leg 513 has an integral leg structure.

The second outer magnetic leg 514 is disposed between a second end of the first magnetic cover 511 and a second end of the second magnetic cover 512. The outer side of the second outer magnetic leg 514 away from the first outer magnetic leg 513 is the fourth lateral side 51d of the magnetic core assembly 51. Moreover, the second outer magnetic leg 514 is penetrated through the second opening 432 of the circuit board 4. The first end and the second end of the first magnetic cover 511 are opposed to each other. The first end and the second end of the second magnetic cover 512 are opposed to each other. As shown in FIGS. 1C and 2, the second outer magnetic leg 514 are formed by two sub-legs. One sub-leg of the second outer magnetic leg 514 is connected with the first magnetic cover 511. The other sub-leg of the second outer magnetic leg 514 is connected with the second magnetic cover 512. In another embodiment, the second outer magnetic leg 514 has an integral leg structure.

In an embodiment, the first inner magnetic leg group 515 includes a first inner magnetic leg 515a and a second inner magnetic leg 515b. The first inner magnetic leg 515a and the second inner magnetic leg 515b are disposed between the first outer magnetic leg 513 and the second outer magnetic leg 514. The first inner magnetic leg 515a and the second inner magnetic leg 515b are located near the first outer magnetic leg 513. That is, the first inner magnetic leg 515a and the second inner magnetic leg 515b are located away from the second outer magnetic leg 514. The first inner magnetic leg 515a is located near the first lateral side 51a of the magnetic core assembly 51. The first inner magnetic leg 515a is penetrated through the third opening 433 of the circuit board 4. The second inner magnetic leg 515b is located near the second lateral side 51b of the magnetic core assembly 51. The second inner magnetic leg 515b is penetrated through the fourth opening 434 of the circuit board 4. Preferably but not exclusively, the shortest distance between the first inner magnetic leg 515a and the first outer magnetic leg 513 and the shortest distance between the second inner magnetic leg 515b and the first outer magnetic leg 513 are equal. In another embodiment, the shortest distance between the first inner magnetic leg 515a and the first outer magnetic leg 513 and the shortest distance between the second inner magnetic leg 515b and the first outer magnetic leg 513 are not equal. As shown in FIGS. 1C and 2, each of the first inner magnetic leg 515a and the second inner magnetic leg 515b includes two sub-legs. One sub-leg of the first inner magnetic leg 515a and one sub-leg of the second inner magnetic leg 515b are connected with the first magnetic cover 511. The other sub-leg of the first inner magnetic leg 515a and the other sub-leg of the second inner magnetic leg 515b are connected with the second magnetic cover 512. In another embodiment, each of the first inner magnetic leg 515a and the second inner magnetic leg 515b has an integral leg structure.

In an embodiment, the second inner magnetic leg group 516 includes a third inner magnetic leg 516a and a fourth inner magnetic leg 516b. The third inner magnetic leg 516a and the fourth inner magnetic leg 516b are disposed between the first outer magnetic leg 513 and the second outer magnetic leg 514. The third inner magnetic leg 516a and the fourth inner magnetic leg 516b are located near the second outer magnetic leg 514. That is, the third inner magnetic leg 516a and the fourth inner magnetic leg 516b are located away from the first outer magnetic leg 513. The third inner magnetic leg 516a is located near the second lateral side 51b of the magnetic core assembly 51. The third inner magnetic leg 516a is penetrated through the fifth opening 435 of the circuit board 4. The fourth inner magnetic leg 516b is located near the first lateral side 51a of the magnetic core assembly 51. The fourth inner magnetic leg 516b is penetrated through the sixth opening 436 of the circuit board 4. Preferably but not exclusively, the shortest distance between the third inner magnetic leg 516a and the second outer magnetic leg 514 and the shortest distance between the fourth inner magnetic leg 516b and the second outer magnetic leg 514 are equal. In another embodiment, the shortest distance between the third inner magnetic leg 516a and the second outer magnetic leg 514 and the shortest distance between the fourth inner magnetic leg 516b and the second outer magnetic leg 514 are not equal. As shown in FIGS. 1C and 2, each of the third inner magnetic leg 516a and the fourth inner magnetic leg 516b includes two sub-legs. One sub-leg of the third inner magnetic leg 516a and one sub-leg of the fourth inner magnetic leg 516b are connected with the first magnetic cover 511. The other sub-leg of the third inner magnetic leg 516a and the other sub-leg of the fourth inner magnetic leg 516b are connected with the second magnetic cover 512. In another embodiment, each of the third inner magnetic leg 516a and the fourth inner magnetic leg 516b has an integral leg structure.

As shown in FIGS. 1A and 1C, two upper switches Q1, two lower switches Q2, two first capacitors C1 and two second capacitors C2 are disposed on the first surface 41 of the circuit board 41 and located beside the second lateral side 51b of the magnetic core assembly 51. One first capacitor C1 and one second capacitor C2 are located beside each other. The other first capacitor C1 and the other second capacitor C2 are located beside each other. The first upper switch Q1, the first lower switch Q2, the second upper switch Q1 and the second lower switch Q2 are sequentially disposed between the two first capacitors C1. The two upper switches Q1 are connected with each other in parallel through corresponding traces (not shown) in the circuit board 4. The two lower switches Q2 are connected with each other in parallel through corresponding traces (not shown) in the circuit board 4. The two first capacitors C1 are connected with each other in parallel through corresponding traces (not shown) in the circuit board 4. The two second capacitors C2 are connected with each other in parallel through corresponding traces (not shown) in the circuit board 4.

As shown in FIGS. 1A and 1C, two first rectifying switches M11 are disposed on the first surface 41 and the second surface 42 of the circuit board 4, respectively. Preferably, the two first rectifying switches M11 are in mirror symmetry with respect to the circuit board 4. The two first rectifying switches M11 are located beside the first lateral side 51a of the circuit board 4. The two first rectifying switches M11 are connected with each other in parallel through corresponding traces (not shown) in the circuit board 4. Similarly, two second rectifying switches M12 are disposed on the first surface 41 and the second surface 42 of the circuit board 4, respectively. Preferably, the two second rectifying switches M12 are in mirror symmetry with respect to the circuit board 4. The two second rectifying switches M12 are located beside the first lateral side 51a of the circuit board 4. The two second rectifying switches M12 are connected with each other in parallel through corresponding traces (not shown) in the circuit board 4. Similarly, two third rectifying switches M21 are disposed on the first surface 41 and the second surface 42 of the circuit board 4, respectively. Preferably, the two third rectifying switches M21 are in mirror symmetry with respect to the circuit board 4. The two third rectifying switches M21 are located beside the first lateral side 51a of the circuit board 4. The two third rectifying switches M21 are connected with each other in parallel through corresponding traces (not shown) in the circuit board 4. Two fourth rectifying switches M22 are disposed on the first surface 41 and the second surface 42 of the circuit board 4, respectively. Preferably, the two fourth rectifying switches M22 are in mirror symmetry with respect to the circuit board 4. The two fourth rectifying switches M22 are located beside the first lateral side 51a of the circuit board 4. The two fourth rectifying switches M22 are connected with each other in parallel through corresponding traces (not shown) in the circuit board 4.

In this embodiment, the second rectifying switch M12, the first rectifying switch M11, the fourth rectifying switch M22 and the third rectifying switch M21 are disposed sequentially. The control circuit 33 is disposed on the first surface 41 of the circuit board 4 and located beside the second rectifying switch M12.

In an embodiment, the first rectifying switch M11 on the first surface 41 of the circuit board 4 and the first rectifying switch M11 on the second surface 42 of the circuit board 4 are partially overlapped with each other along the vertical direction. Similarly, the second rectifying switch M12 on the first surface 41 of the circuit board 4 and the second rectifying switch M12 on the second surface 42 of the circuit board 4 are partially overlapped with each other along the vertical direction. Similarly, the third rectifying switch M21 on the first surface 41 of the circuit board 4 and the third rectifying switch M21 on the second surface 42 of the circuit board 4 are partially overlapped with each other along the vertical direction. Similarly, the fourth rectifying switch M22 on the first surface 41 of the circuit board 4 and the fourth rectifying switch M22 on the second surface 42 of the circuit board 4 are partially overlapped with each other along the vertical direction.

Please refer to FIG. 1B again. The power conversion module 1 further includes a positive output pin 61, two negative output pins 62, a positive input pin 63, a plurality of signal pins 64 and an input inductor Lin. The positive output pin 61 is used as the output positive terminal Vo+ as shown in FIG. 3. The positive output pin 61 is disposed on the second surface 42 of the circuit board 4 and located beside the second lateral side 51b of the magnetic core assembly 51. The two negative output pins 62 are used as the output negative terminal Vo− as shown in FIG. 3. The two negative output pins 62 are disposed on the second surface 42 of the circuit board 4 and located beside the first lateral side 51a of the magnetic core assembly 51. The second rectifying switch M12, the first rectifying switch M11, the fourth rectifying switch M22 and the third rectifying switch M21 are located between the two negative output pins 62. The positive input pin 63 is used as the input positive terminal Vin+ as shown in FIG. 3. The positive input pin 63 is disposed on the second surface 42 of the circuit board 4. The plurality of signal pins 64 are used for transferring control signals (e.g., the PWM signals for controlling the rectifying switches M11, M12, M21 and M22), the detection signals, the temperature signals or associated signals. Consequently, the purpose of homogenizing the currents of different modules, synchronizing the PWM signals of different modules or communicating different modules can be achieved. The plurality of signal pins 64 are disposed on the second surface 42 of the circuit board 4. The plurality of signal pins 64 and the positive input pin 63 are disposed in a line. The plurality of signal pins 64 are located beside one of the two negative output pins 62. In an embodiment, the plurality of signal pins 64 are not aligned with the rectifying switches M11, M12, M21 and M22.

The input inductor Lin is disposed on the second surface 42 of the circuit board 4. In addition, the input inductor Lin is located beside the third side 51c of the magnetic core assembly 51. In an embodiment, the power conversion module 1 further includes an auxiliary power pin 65. The auxiliary power pin 65 is used to provide auxiliary power to the power conversion module 1. The auxiliary power pin 65 is disposed on the second surface 42 of the circuit board 4. In addition, the auxiliary power pin 65 is located beside the negative output pin 62. Moreover, the negative output pin 62 is located between the auxiliary power pin 65 and the first side 51a of the magnetic core assembly 51.

For succinctness, the output capacitor Co in FIG. 3 is not shown in FIGS. 1A, 1B and 1C. It is noted that the output capacitor Co may be disposed on any position of the circuit board 4 or disposed on the system board. In the following embodiments, the output capacitor Co disposed on the system board is taken as an example.

Please refer to FIG. 2. A first channel 517a is formed between the first inner magnetic leg group 515 and the first outer magnetic leg 513. The first channel 517a is extended from the first lateral side 51a of the magnetic core assembly 51 to the second lateral side 51b of the magnetic core assembly 51. A second channel 517b is formed between the second inner magnetic leg group 516 and the first inner magnetic leg group 515. The second channel 517b is extended from the first lateral side 51a of the magnetic core assembly 51 to the second lateral side 51b of the magnetic core assembly 51. A third channel 517c is formed between the second inner magnetic leg group 516 and the second outer magnetic leg 514. The third channel 517c is extended from the first lateral side 51a of the magnetic core assembly 51 to the second lateral side 51b of the magnetic core assembly 51. The second channel 517b is located between the first channel 517a and the third channel 517c. Moreover, A fourth channel 517d is formed between the first inner magnetic leg 515a and the second inner magnetic leg 515b of the first inner magnetic leg group 515. The fourth channel 517d is in communication with the first channel 517a and the second channel 517b. A fifth channel 517e is formed between the third inner magnetic leg 516a and the fourth inner magnetic leg 516b of the second inner magnetic leg group 516. The fifth channel 517e is in communication with the second channel 517b and the third channel 517c.

In an embodiment, the first inner magnetic leg 515a and the fourth inner magnetic leg 516b are coplanar with the first lateral side 51a of the magnetic core assembly 51, and the second inner magnetic leg 515b and the third inner magnetic leg 516a are coplanar with the second lateral side 51b of the magnetic core assembly 51. In another embodiment, the first inner magnetic leg 515a and the fourth inner magnetic leg 516b are not coplanar with the first lateral side 51a of the magnetic core assembly 51, and the second inner magnetic leg 515b and the third inner magnetic leg 516a are not coplanar with the second lateral side 51b of the magnetic core assembly 51.

The method of winding the winding assembly 52 will be described with reference to FIG. 5. For succinctness, the first magnetic cover 511 of the magnetic core assembly 51 is not shown. As shown in FIG. 5, the winding assembly 52 includes the primary winding assembly NP (i.e., the first primary winding NP1 and the second primary winding NP2) and the four coupled windings (i.e., the first secondary winding NS11, the second secondary winding NS12, the third secondary winding NS21 and the fourth secondary winding NS22).

A first part of the first channel 517a is disposed between the first inner magnetic leg 515a and the first outer magnetic leg 513. A second part of the first channel 517a is disposed between the second inner magnetic leg 515b and the first outer magnetic leg 513. A first part of the second channel 517b is disposed between the first inner magnetic leg 515a and the fourth inner magnetic leg 516b. A second part of the second channel 517b is disposed between the second inner magnetic leg 515b and the third inner magnetic leg 516a. A first part of the third channel 517c is disposed between the fourth inner magnetic leg 516b and the second outer magnetic leg 514. A second part of the third channel 517c is disposed between the third inner magnetic leg 516a and the second outer magnetic leg 514.

The first terminal of the primary winding assembly NP is located near the second side 51b of the magnetic core assembly 51 and the second part of the first channel 517a. The second terminal of the primary winding assembly NP is located near the second lateral side 51b of the magnetic core assembly 51 and the second part of the third channel 517c. The primary winding assembly NP is sequentially transferred through the second part of the first channel 517a, the fourth channel 517d, the fifth channel 517e, the first part of the third channel 517a, the outer side of the fourth inner magnetic leg 516b, the first part of the first channel 517a, the fourth channel 517d, the fifth channel 517e and the second part of the third channel 517a from the first terminal to the second terminal.

Moreover, at least two segments of the primary winding assembly NP in the fourth channel 517d or the fifth channel 517e are crossed with each other. The primary winding assembly NP is wound around the first inner magnetic leg 515a and the fourth inner magnetic leg 516b from the first terminal to the second terminal along a first direction. The primary winding assembly NP is wound around the second inner magnetic leg 515b and the third inner magnetic leg 516a from the first terminal to the second terminal along a second direction. The first direction and the second direction are opposite. For example, the first direction is a clockwise direction, and the second direction is a counterclockwise direction.

In an embodiment, the primary winding assembly NP is wound around each of the first inner magnetic leg 515a, the second inner magnetic leg 515b, the third inner magnetic leg 516a and the fourth inner magnetic leg 516b for one turn. The portion of the primary winding assembly NP wound around the first inner magnetic leg 515a and the portion of the primary winding assembly NP wound around the second inner magnetic leg 515b is the first primary winding NP1. The portion of the primary winding assembly NP wound around the third inner magnetic leg 516a and the portion of the primary winding assembly NP wound around the fourth inner magnetic leg 516b is the second primary winding NP2. By using the winding method of this embodiment, the directions and the amplitudes of the AC magnetic fluxes generated by the primary winding NP and applied to the first inner magnetic leg 515a and the fourth inner magnetic leg 516b are identical, and the directions and the amplitudes of the AC magnetic fluxes generated by the primary winding NP and applied to the second inner magnetic leg 515b and the third inner magnetic leg 516a are identical. The direction of the AC magnetic flux generated by the primary winding NP and applied to the first inner magnetic leg 515a and the fourth inner magnetic leg 516b is opposite to the direction of the AC magnetic flux generated by the primary winding NP and applied to the second inner magnetic leg 515b and the third inner magnetic leg 516a. The amplitudes of the AC magnetic fluxes generated by the primary winding NP and applied to the four inner magnetic legs are identical, and the total of the AC magnetic fluxes generated by the primary winding NP and applied to the four inner magnetic legs is zero in one switching cycle.

Please also refer to FIG. 3. The first terminal of the primary winding assembly NP is connected with the midpoint A of the switch bridge arm 21 and thus connected with the switching circuit 2. The second terminal of the primary winding assembly NP is connected with the midpoint B of the capacitor bridge arm 22 and thus connected with the switching circuit 2. That is, the voltage across the first terminal and the second terminal of the primary winding assembly NP is equal to VAB.

As mentioned above, the primary winding assembly NP is wound around each of the four inner magnetic legs for one turn. It is noted that the turn number of the primary winding assembly NP wound around each of the four inner magnetic legs is not restricted. It is noted that the method of winding the primary winding assembly NP around each of the four inner magnetic legs is not restricted. In another embodiment, the primary winding assembly NP is wound around each of the four inner magnetic legs for more than one turn (e.g., X turns). For example, the primary winding assembly NP is wound around the second inner magnetic leg 515b and the third inner magnetic leg 516a for X turns, and then the primary winding assembly NP is wound around the first inner magnetic leg 515a and the fourth inner magnetic leg 516b for X turns. Alternatively, the primary winding assembly NP is wound around the second inner magnetic leg 515b and the third inner magnetic leg 516a for one turn, and then the primary winding assembly NP is wound around the first inner magnetic leg 515a and the fourth inner magnetic leg 516b for one turn, wherein this process is performed for X times.

Please refer to FIG. 5. The first rectifying switch M11 and the second rectifying switch M12 are formed as the first rectifying circuit 31 as shown in FIG. 3

The first terminal of the first secondary winding NS11 is connected with the drain terminal of the first rectifying switch M11. The first terminal of the first secondary winding NS11 is located near the first lateral side 51a of the magnetic core assembly 51 and the first part of the second channel 517b. The second terminal of the first secondary winding NS11 is located near the second lateral side 51b of the magnetic core assembly 51 and the second part of the first channel 517a. The first secondary winding NS11 is sequentially transferred through the first part of the second channel 517b, the fourth channel 517d and the second part of the first channel 517a from the first terminal to the second terminal.

The first terminal of the second secondary winding NS12 is connected with the drain terminal of the second rectifying switch M12. The first terminal of the second secondary winding NS12 is located beside the first lateral side 51a of the magnetic core assembly 51 and the first part of the first channel 517a. The second terminal of the second secondary winding NS12 is located beside the second lateral side 51b of the magnetic core assembly 51 and the second part of the second channel 517b. The second secondary winding NS12 is sequentially transferred through the first part of the first channel 517a, the fourth channel 517d and the second part of the second channel 517b from the first terminal to the second terminal. The first secondary winding NS11 and the second secondary winding NS12 in the fourth channel 517d are crossed with each other.

Moreover, the second terminal of the second secondary winding NS12 and the second terminal of the first secondary winding NS11 are connected with each other at the outer side the second inner magnetic leg 515b. Consequently, the second terminal of the second secondary winding NS12 and the second terminal of the first secondary winding NS11 are electrically connected with the first terminal of the output capacitor Co and the output positive terminal Vo+. The source terminal of the first rectifying switch M11 and the source terminal of the second rectifying switch M12 are connected with each other at the outer side of the first inner magnetic leg 515a. Consequently, the source terminal of the first rectifying switch M11 and the source terminal of the second rectifying switch M12 are electrically connected with the second terminal of the output capacitor Co and the output negative terminal Vo−.

Please refer to FIG. 5 again. The third rectifying switch M21 and the fourth rectifying switch M22 are formed as the second rectifying circuit 32 as shown in FIG. 3.

The first terminal of the third secondary winding NS21 is connected with the drain terminal of the third rectifying switch M21. The first terminal of the third secondary winding NS21 is located near the first lateral side 51a of the magnetic core assembly 51 and the first part of the third channel 517c. The second terminal of the third secondary winding NS21 is located near the second lateral side 51b of the magnetic core assembly 51 and the second part of the second channel 517b. The third secondary winding NS21 is sequentially transferred through the first part of the third channel 517c, the fifth channel 517e and the second part of the second channel 517b from the first terminal to the second terminal.

The first terminal of the fourth secondary winding NS22 is connected with the drain terminal of the fourth rectifying switch M22. The first terminal of the fourth secondary winding NS22 is located near the first lateral side 51a of the magnetic core assembly 51 and the first part of the second channel 517b. The second terminal of the fourth secondary winding NS22 is located near the second lateral side 51b of the magnetic core assembly 51 and the second part of the second channel 517b. The fourth secondary winding NS22 is sequentially transferred through the first part of the second channel 517b, the fifth channel 517e and the second part of the third channel 517c from the first terminal to the second terminal. The third secondary winding NS21 and the fourth secondary winding NS22 in the fifth channel 517e are crossed with each other.

In addition, the second terminal of the fourth secondary winding NS22 and the second terminal of the third secondary winding NS21 are connected with each other at the outer side of the fourth inner magnetic leg 516b. Consequently, the second terminal of the fourth secondary winding NS22 and the second terminal of the third secondary winding NS21 are electrically connected with the first terminal of the output capacitor Co and the output positive terminal Vo+. The source terminal of the third rectifying switch M21 and the source terminal of the fourth rectifying switch M22 are connected with each other at the outer side of the fourth inner magnetic leg 516b. Consequently, the source terminal of the third rectifying switch M21 and the source terminal of the fourth rectifying switch M22 are electrically connected with the second terminal of the output capacitor Co and the output negative terminal Vo−.

In case that the DC currents flow through the first secondary winding NS11, the second secondary winding NS12, the third secondary winding NS21 and the fourth secondary winding NS22 along the same direction, the DC magnetic flux generated by the first secondary winding NS11 and applied to the first inner magnetic leg group 515 and the DC magnetic flux generated by the second secondary winding NS12 and applied to the first inner magnetic leg group 515 are cancelled out. In addition, the DC magnetic flux generated by the third secondary winding NS21 and applied to the second inner magnetic leg group 516 and the DC magnetic flux generated by the fourth secondary winding NS22 and applied to the second inner magnetic leg group 516 are cancelled out.

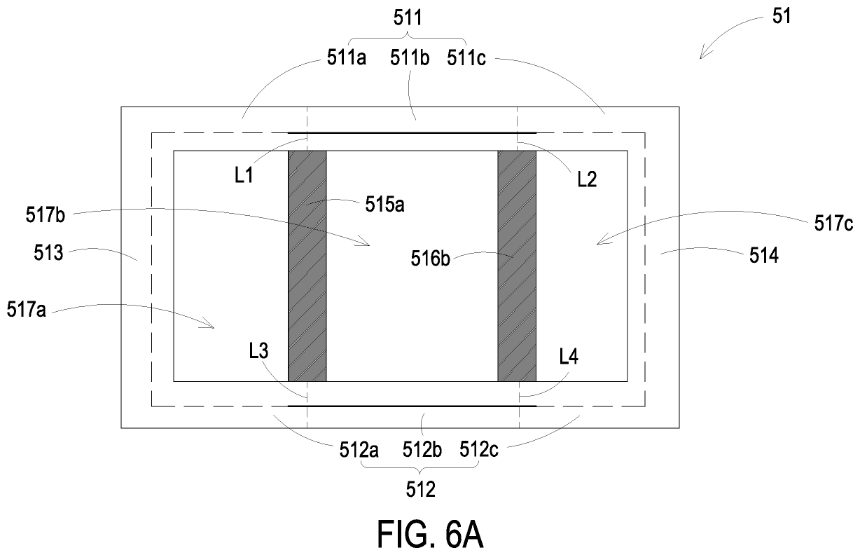

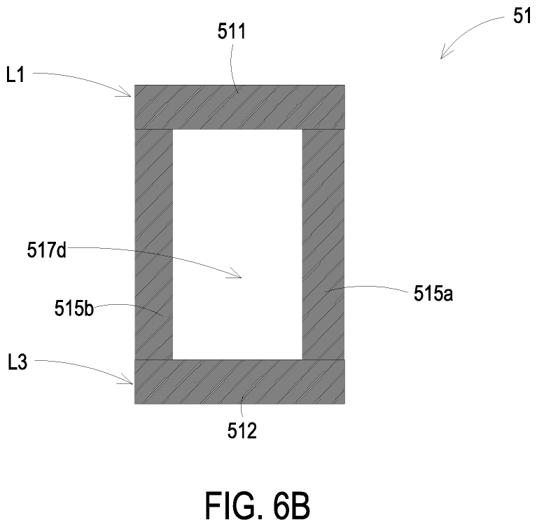

Please refer to FIG. 6A and FIGS. 1A and 2. FIG. 6A is a schematic cross-sectional view illustrating the magnetic device of the power conversion module as shown in FIG. 1A and taken along the line A-A′. In FIG. 6A, only the first magnetic cover 511, the second magnetic cover 512, the first outer magnetic leg 513, the second outer magnetic leg 514, the first inner magnetic leg 515a and the fourth inner magnetic leg 516b are shown.

As shown in FIG. 6A, the first inner magnetic leg 515a, the second inner magnetic leg 515b, the third inner magnetic leg 516a and the fourth inner magnetic leg 516b of the magnetic core assembly 51 are made of low magnetic resistance material. Moreover, the equivalent magnetic resistances of the first inner magnetic leg 515a, the second inner magnetic leg 515b, the third inner magnetic leg 516a and the fourth inner magnetic leg 516b are equal. The rest of the magnetic core assembly 51 is made of high magnetic resistance material. Consequently, the equivalent magnetic resistance of each of the first inner magnetic leg 515a, the second inner magnetic leg 515b, the third inner magnetic leg 516a and the fourth inner magnetic leg 516b is lower than the equivalent magnetic resistance of the rest of the magnetic core assembly 51.

FIG. 6B is a schematic cross-sectional view illustrating the magnetic device of the power conversion module as shown in FIG. 1A and taken along the line B-B′. In FIG. 6B, only the first inner magnetic leg 515a and the second inner magnetic leg 515b are shown. The structures of the third inner magnetic leg 516a and the fourth inner magnetic leg 516b are similar to the structures of the first inner magnetic leg 515a and the second inner magnetic leg 515b, and not redundantly described herein.

As shown in FIG. 6B, the region of the first magnetic cover 511 between the first inner magnetic leg 515a and the second inner magnetic leg 515b is made of the low magnetic resistance material. Similarly, the region of the first magnetic cover 511 between the third inner magnetic leg 516a and the fourth inner magnetic leg 516b is made of the low magnetic resistance material. Similarly, the region of the second magnetic cover 512 between the first inner magnetic leg 515a and the second inner magnetic leg 515b is made of the low magnetic resistance material. Similarly, the region of the second magnetic cover 512 between the third inner magnetic leg 516a and the fourth inner magnetic leg 516b is made of the low magnetic resistance material. The rest of the magnetic core assembly 51 is made of high magnetic resistance material. Consequently, the equivalent magnetic resistance of the region marked with black matrix shown in FIG. 6B of the magnetic core assembly 51 is lower than the equivalent magnetic resistance of the rest of the magnetic core assembly 51.

Please refer to FIGS. 2, 6A and 6B. A first line L1 passes through the projection area of the first inner magnetic leg 515a on the first magnetic cover 511 and the projection area of the second inner magnetic leg 515b on the first magnetic cover 511. That is, the first line L1 passes through two projection areas. A second line L2 passes through the projection area of the third inner magnetic leg 516a on the first magnetic cover 511 and the projection area of the fourth inner magnetic leg 516b on the first magnetic cover 511. That is, the second line L2 passes through two projection areas. A third line L3 passes through the projection area of the first inner magnetic leg 515a on the second magnetic cover 512 and the projection area of the second inner magnetic leg 515b on the second magnetic cover 512. That is, the third line L3 passes through two projection areas. A fourth line L4 passes through the projection area of the third inner magnetic leg 516a on the second magnetic cover 512 and the projection area of the fourth inner magnetic leg 516b on the second magnetic cover 512. That is, the fourth line L4 passes through two projection areas.

Please refer to FIG. 6A. The first magnetic cover 511 of the magnetic core assembly 51 is divided into three regions according to the first line L1 and the second line L2. The first region 511a is disposed between the first end of the first magnetic cover 511 and the first line L1. The second region 511b is disposed between the first line L1 and the second line L2. The third region 511c is disposed between the second line L2 and the second end of the first magnetic cover 511.

Similarly, the second magnetic cover 512 of the magnetic core assembly 51 is divided into three regions according to the third line L3 and the fourth line L4. The first region 512a is disposed between the first end of the second magnetic cover 512 and the third line L3. The second region 512b is disposed between the third line L3 and the fourth line L4. The third region 512c is disposed between the fourth line L4 and the second end of the second magnetic cover 512.

In an embodiment, the first region 511a of the first magnetic cover 511, the first outer magnetic leg 513 and the first region 512a of the second magnetic cover 512 are made of high magnetic resistance material, wherein the equivalent magnetic resistance is Rm. The third region 511c of the first magnetic cover 511, the second outer magnetic leg 514 and the third region 512c of the second magnetic cover 512 are made of high magnetic resistance material, wherein the equivalent magnetic resistance is Rm. The second region 511b of the first magnetic cover 511 and the second region 512b of the second magnetic cover 512 are made of high magnetic resistance material. In an embodiment, the equivalent magnetic resistance of the second region 511b of the first magnetic cover 511 is 2Rm, and the equivalent magnetic resistance of the second region 512b of the second magnetic cover 512 is 2Rm. In another embodiment, the equivalent magnetic resistance of the second region 511b of the first magnetic cover 511 is Rm, and the equivalent magnetic resistance of the second region 512b of the second magnetic cover 512 is Rm.

In an embodiment, the low magnetic resistance material is a high magnetic permeability material without an air gap, e.g., ferrite. Moreover, the high magnetic resistance material is a high magnetic permeability material with a centralized air gap (e.g., ferrite with a centralized air gap) or iron powder with a distributed air gap.

Please refer to FIG. 5 again. A first AC voltage across the first terminal and the second terminal of the first primary winding NP1 is equal to VAB/2. Similarly, a second AC voltage across the first terminal and the second terminal of the second primary winding NP2 is equal to VAB/2. The first AC voltage is equal to the second AC voltage. Due to the first AC voltage, the amplitude of the AC magnetic flux generated by the first primary winding NP1 and applied to the first inner magnetic leg 515a and the amplitude of the AC magnetic flux generated by the first primary winding NP1 and applied to the second inner magnetic leg 515b are identical. However, the directions of the AC magnetic fluxes are opposite. Due to the second AC voltage, the amplitude of the AC magnetic flux generated by the second primary winding NP2 and applied to the third inner magnetic leg 516a and the amplitude of the AC magnetic flux generated by the second primary winding NP2 and applied to the fourth inner magnetic leg 516b are identical. However, the directions of the AC magnetic fluxes are opposite.

The direction of the AC magnetic flux generated by the primary winding assembly NP and applied to the first inner magnetic leg 515a and the direction of the AC magnetic flux generated by the primary winding assembly NP and applied to the fourth inner magnetic leg 516b are opposite. Similarly, the direction of the AC magnetic flux generated by the primary winding assembly NP and applied to the second inner magnetic leg 515b and the direction of the AC magnetic flux generated by the primary winding assembly NP and applied to the third inner magnetic leg 516a are opposite. The direction of the AC magnetic flux generated by the primary winding assembly NP and applied to the first inner magnetic leg 515a and the direction of the AC magnetic flux generated by the primary winding assembly NP and applied to the third inner magnetic leg 516a are identical. Similarly, the direction of the AC magnetic flux generated by the primary winding assembly NP and applied to the second inner magnetic leg 515b and the direction of the AC magnetic flux generated by the primary winding assembly NP and applied to the fourth inner magnetic leg 516b are identical. Moreover, the amplitudes of the AC magnetic fluxes generated by the primary winding assembly NP and applied to the fourth inner magnetic legs are identical. In each switching cycle, the total of the AC magnetic fluxes applied to the four inner magnetic legs is zero.

The direction of the AC magnetic flux applied to the first outer magnetic leg 513 and the direction of the AC magnetic flux applied to the second outer magnetic leg 514 are opposite. The amplitude of the AC magnetic flux applied to the first outer magnetic leg 513 and the amplitude of the AC magnetic flux applied to the second outer magnetic leg 514 are identical. That is, the amplitude of the AC magnetic flux applied to the first outer magnetic leg 513 (or the amplitude of the AC magnetic flux applied to the second outer magnetic leg 514) is equal to a half of the total of the AC magnetic flux generated by the AC voltage across the first terminal and the second terminal of the first secondary winding NS11 and the AC magnetic flux generated by the AC voltage across the first terminal and the second terminal of the second secondary winding NS12, or the amplitude of the AC magnetic flux applied to the first outer magnetic leg 513 (or the amplitude of the AC magnetic flux applied to the second outer magnetic leg 514) is equal to a half of the total of the AC magnetic flux generated by the AC voltage across the first terminal and the second terminal of the third secondary winding NS21 and the AC magnetic flux generated by the AC voltage across the first terminal and the second terminal of the fourth secondary winding NS22.

The DC magnetic fluxes applied to the first inner magnetic leg 515a, the second inner magnetic leg 515b, the third inner magnetic leg 516a and the fourth inner magnetic leg 516b are all zero. The direction of the DC magnetic flux applied to the first outer magnetic leg 513 and the direction of the DC magnetic flux applied to the second outer magnetic leg 514 are opposite. The amplitude of the DC magnetic flux applied to the first outer magnetic leg 513 and the amplitude of the DC magnetic flux applied to the second outer magnetic leg 514 are equal. For example, the amplitude is equal to Io/(4×Rm), wherein Io is the equivalent DC current of the currents outputted from the four secondary windings. The currents outputted from the four secondary windings are nearly equal. As mentioned above in FIG. 6A, Rm is the equivalent magnetic resistance of the first region 511a of the first magnetic cover 511, the first outer magnetic leg 513 and the first region 512a of the second magnetic cover 512 or the equivalent magnetic resistance of the third region 511c of the first magnetic cover 511, the second outer magnetic leg 514 and the third region 512c of the second magnetic cover 512. The direction of the DC magnetic flux applied to the second region 511b of the first magnetic cover 511 and the direction of the DC magnetic flux applied to the second region 512b of the second magnetic cover 512 are opposite. The amplitude of the DC magnetic flux applied to the second region 511b of the first magnetic cover 511 and the amplitude of the DC magnetic flux applied to the second region 512b of the second magnetic cover 512 are equal. For example, the amplitude is equal to Io/(4×Rm).

Due to the above circuitry structure, the following benefits are achieved. Due to the first inner magnetic leg 515a and the first outer magnetic leg 513, the steady-state output ripple current of the second secondary winding NS12 is decreased, and the equivalent steady-state inductance of the second secondary winding NS12 is increased. Due to the second inner magnetic leg 515b and the first outer magnetic leg 513, the steady-state output ripple current of the first secondary winding NS11 is decreased, and the equivalent steady-state inductance of the first secondary winding NS11 is increased. Due to the third inner magnetic leg 516a and the second outer magnetic leg 514, the steady-state output ripple current of the third secondary winding NS21 is decreased, and the equivalent steady-state inductance of the third secondary winding NS21 is increased. Due to the fourth inner magnetic leg 516b and the second outer magnetic leg 514, the steady-state output ripple current of the fourth secondary winding NS22 is decreased, and the equivalent steady-state inductance of the fourth secondary winding NS22 is increased. By adjusting the magnetic resistance Rm, the magnitudes of the ripple currents and saturation currents of the first secondary winding NS11, the second secondary winding NS12, the third secondary winding NS21 and the fourth secondary winding NS22 are correspondingly adjusted. For example, in case that the magnetic resistance Rm is increased, the magnitudes of the ripple currents and saturation currents of the first secondary winding NS11, the second secondary winding NS12, the third secondary winding NS21 and the fourth secondary winding NS22 are increased.

In the above embodiment, the present disclosure provides the power conversion module 1. The magnetic core assembly 51 and the winding assembly 52 in the magnetic device 5 of the power conversion module 1 are specially designed. Consequently, the voltage reduction function of the transformer T is achieved, and the 4-phase output inductor with large inductance is obtained. That is, the power conversion module 1 with the single-stage converter can achieve the voltage reduction function and the filtering function. In comparison with the conventional power conversion module with two stage converters, the magnetic device 5 of the power conversion module 1 of the present disclosure has reduced volume and increased integration. The power conversion module 1 has the advantages of small size, high efficiency and expended application. Moreover, each secondary winding of the winding assembly 52 is transferred through corresponding channels of the magnetic core assembly 51. Consequently, the voltage reduction function and the filtering function are achieved. In comparison with the arrangement of the secondary windings in the conventional power conversion module, the secondary winding of the winding assembly 52 of the magnetic device 5 of the present disclosure has the shorter connection path, the lower parasitic resistance and lower conduction losses.

Moreover, the magnetic device 5 of the power conversion module 1 includes four secondary windings. The overall output current is distributed to the four secondary windings. Consequently, the power loss is low, and the thermal resistance is low. The two primary windings of the winding assembly 52 of the magnetic device 5 are connected with each other in series and coupled with the four secondary windings. The input current of the primary windings is low. Consequently, the current-sharing efficacy between the first secondary winding NS11 and the second secondary winding NS12 and the current-sharing efficacy between the third secondary winding NS21 and the fourth secondary winding NS22 are enhanced. Consequently, the power conversion module 1 of the present disclosure provides a larger output current, a larger output inductance, a smaller ripple current, a smaller volume, a higher power density and a higher efficiency.

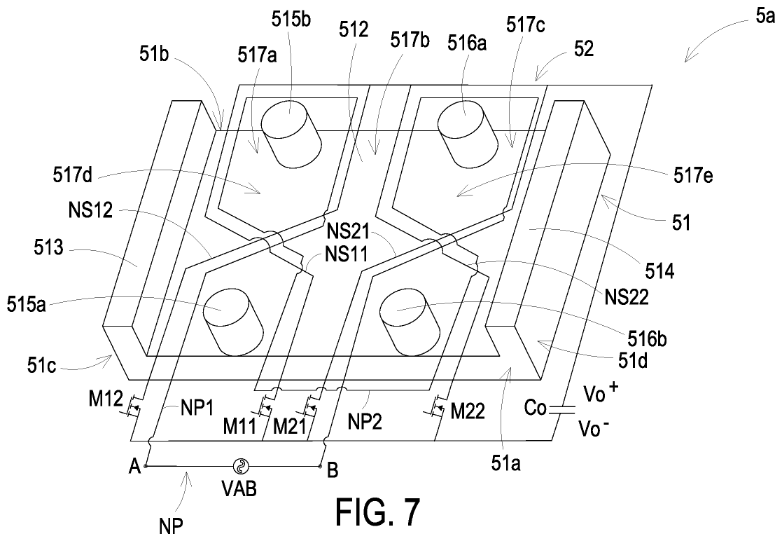

FIG. 7 schematically illustrates the magnetic core assembly and the winding assembly in the magnetic device of a power conversion module according to a second embodiment of the present disclosure, in which the first magnetic cover is not shown. In comparison with the magnetic device 5 of the first embodiment, the winding method of the primary winding assembly NP of the magnetic device 5a of this embodiment is distinguished.

Please refer to FIG. 7. The first terminal of the first primary winding NP1 is located near the first lateral side 51a of the magnetic core assembly 51 and the first part of the first channel 517a. The second terminal of the first primary winding NP1 is located near the first lateral side 51a of the magnetic core assembly 51 and the first part of the second channel 517b. The first primary winding NP1 is sequentially transferred through the first part of the first channel 517a, the fourth channel 517d, the second part of the second channel 517b, the outer side of the second inner magnetic leg 515b, the second part of the first channel 517a, the fourth channel 517d and the first part of the second channel 517b from the first terminal to the second terminal. Consequently, at least two segments of the first primary winding NP1 in the fourth channel 517d are crossed with each other. The first primary winding NP1 is wound around the first inner magnetic leg 515a and the second inner magnetic leg 515b. For example, the first primary winding NP1 is wound around each of the first inner magnetic leg 515a and the second inner magnetic leg 515b for one turn.

The first terminal of the second primary winding NP2 is connected with the second terminal of the first primary winding NP1. The first terminal of the second primary winding NP2 is located near the first lateral side 51a of the magnetic core assembly 51 and the first part of the third channel 517c. The second terminal of the second primary winding NP2 is located near the first lateral side 51a of the magnetic core assembly 51 and the first part of the second channel 517b. The second primary winding NP2 is sequentially transferred through the first part of the third channel 517c, the fifth channel 5172, the second part of the second channel 517b, the outer side of the third inner magnetic leg 516a, the second part of the third channel 517c, the fifth channel 517e and the first part of the second channel 517b from the first terminal to the second terminal. Consequently, at least two segments of the second primary winding NP2 in the fourth channel 517d are crossed with each other. The second primary winding NP2 is wound around the third inner magnetic leg 516a and the fourth inner magnetic leg 516b. For example, the second primary winding NP2 is wound around each of the third inner magnetic leg 516a and the fourth inner magnetic leg 516b for one turn.

The first primary winding NP1 is wound around the first inner magnetic leg 515a from the first terminal to the second terminal along a first direction. The first primary winding NP1 is wound around the second inner magnetic leg 515b from the first terminal to the second terminal along a second direction. The second primary winding NP2 is wound around the third inner magnetic leg 516a from the first terminal to the second terminal along the first direction. The second primary winding NP2 is wound around the fourth inner magnetic leg 516b from the first terminal to the second terminal along the second direction. The first direction and the second direction are opposite. For example, the first direction is a clockwise direction, and the second direction is a counterclockwise direction; or the first direction is the counterclockwise direction, and the second direction is the clockwise direction. It is noted that the directions are not limited to the above embodiment and are adjustable according to the practical requirements as long as the common-polarity terminal relationship between the primary winding and the secondary winding is satisfied.

Please also refer to FIG. 3 again. The first terminal of the first primary winding NP1 is connected with the midpoint A of the switch bridge arm 21 and thus connected with the switching circuit 2. The second terminal of the second primary winding NP2 is connected with the midpoint B of the capacitor bridge arm 22 and thus connected with the switching circuit 2. That is, the voltage across the first terminal and the second terminal of the primary winding assembly NP is equal to VAB.

In an embodiment, the primary winding assembly NP is wound around each of the four inner magnetic legs for one turn. It is noted that the turn number of the primary winding assembly NP wound around each of the four inner magnetic legs is not restricted. It is noted that the direction of the primary winding assembly NP around each of the four inner magnetic legs is not restricted. In another embodiment, the primary winding assembly NP is wound around each of the four inner magnetic legs for more than one turn (e.g., X turns). For example, the first primary winding NP1 is wound around the first inner magnetic leg 515a and the second inner magnetic leg 515b for X turns. That is, the first primary winding NP1 is transferred through the fourth channel 517d for 2X times, and crossed X times in fourth channel 517d. Alternatively, the first primary winding NP1 is firstly wound around the first inner magnetic leg 515a for X turns, and then the first primary winding NP1 is wound around the second inner magnetic leg 515b for X turns. That is, the first primary winding NP1 is transferred through the fourth channel 517d for 2X times, and crossed one time in the fourth channel 517d.

For example, the second primary winding NP2 is wound around the third inner magnetic leg 516a and the fourth inner magnetic leg 516b for X turns. That is, the second primary winding NP2 is transferred through the fifth channel 517e for 2X times, and crossed X times in fifth channel 517e. Alternatively, the second primary winding NP2 is firstly wound around the fourth inner magnetic leg 516b for X turns, and then the second primary winding NP2 is wound around the third inner magnetic leg 516a for X turns. That is, the second primary winding NP2 is transferred through the fifth channel 517e for 2X times, and crossed one time in the fifth channel 517e.

In comparison with FIG. 5, the methods of winding the third secondary winding NS21 and the fourth secondary winding N22 of the magnetic device 5a of this embodiment are distinguished. In this embodiment, the first terminal of the third secondary winding NS21 is connected with the drain terminal of the third rectifying switch M21. The first terminal of the third secondary winding NS21 is located near the first lateral side 51a of the magnetic core assembly 51 and the first part of the second channel 517b. The second terminal of the third secondary winding NS21 is located near the second lateral side 51b of the magnetic core assembly 51 and the second part of the third channel 517c. The third secondary winding NS21 is sequentially transferred through the first part of the second channel 517b, the fifth channel 517e and the second part of the third channel 517c from the first terminal to the second terminal.

The first terminal of the fourth secondary winding NS22 is connected with the drain terminal of the fourth rectifying switch M22. The first terminal of the fourth secondary winding NS22 is located near the first lateral side 51a of the magnetic core assembly 51 and the first part of the third channel 517c. The second terminal of the fourth secondary winding NS22 is located near the second lateral side 51b of the magnetic core assembly 51 and the second part of the second channel 517b. The fourth secondary winding NS22 is sequentially transferred through the first part of the third channel 517c, the fifth channel 517e and the second part of the second channel 517b from the first terminal to the second terminal. The third secondary winding NS21 and the fourth secondary winding NS22 in the fifth channel 517e are crossed with each other. The effects of the winding methods of this embodiment are similar to those of FIG. 5.

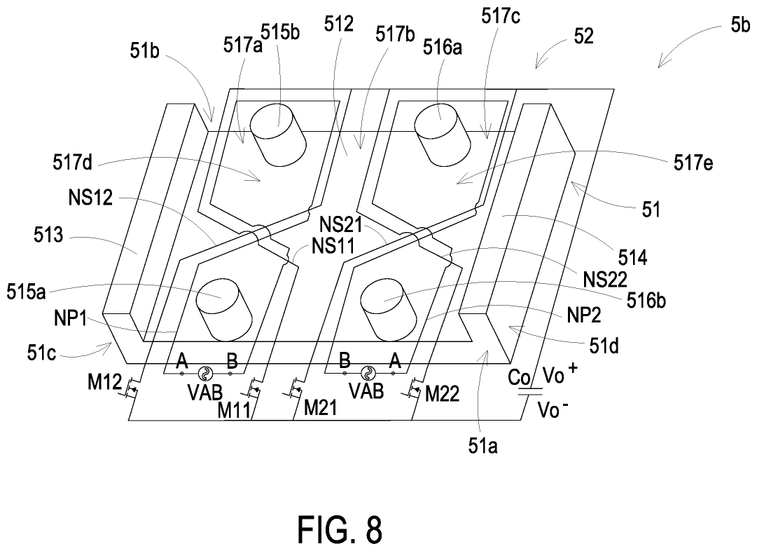

FIG. 8 schematically illustrates the magnetic core assembly and the winding assembly in the magnetic device of a power conversion module according to a third embodiment of the present disclosure, in which the first magnetic cover is not shown. In comparison with the magnetic device 5 of the first embodiment and the magnetic device 5a of the second embodiment, the winding method of the primary winding assembly NP of the magnetic device 5b of this embodiment is distinguished. In the first embodiment and the second embodiment, the first primary winding NP1 and the second primary winding NP2 are connected with each other in series. In this embodiment, the first primary winding NP1 and the second primary winding NP2 are connected with each other in parallel. The winding methods of the secondary windings NS11, NS12, NS21 and NS22 are similar to those of FIG. 7, and not redundantly described herein.

The first terminal of the first primary winding NP1 is located near the first lateral side 51a of the magnetic core assembly 51 and the first part of the first channel 517a. The first terminal of the second primary winding NP2 is located near the first lateral side 51a of the magnetic core assembly 51 and the first part of the third channel 517c. Moreover, the first terminal of the first primary winding NP1 and the first terminal of the second primary winding NP2 are connected with the midpoint A of the switch bridge arm. The second terminal of the first primary winding NP1 and the second terminal of the second primary winding NP2 are located near the first lateral side 51a of the magnetic core assembly 51 and the first part of the second channel 517b. Moreover, the second terminal of the first primary winding NP1 and the second terminal of the second primary winding NP2 are connected with the midpoint B of the capacitor bridge arm.

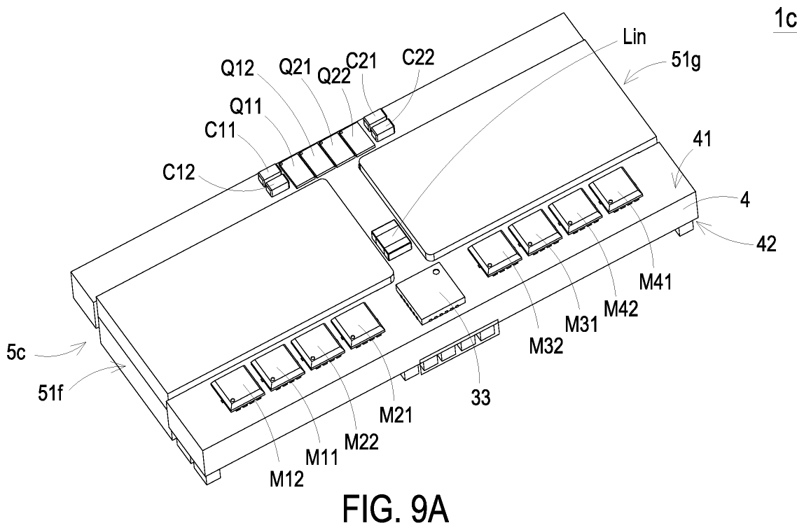

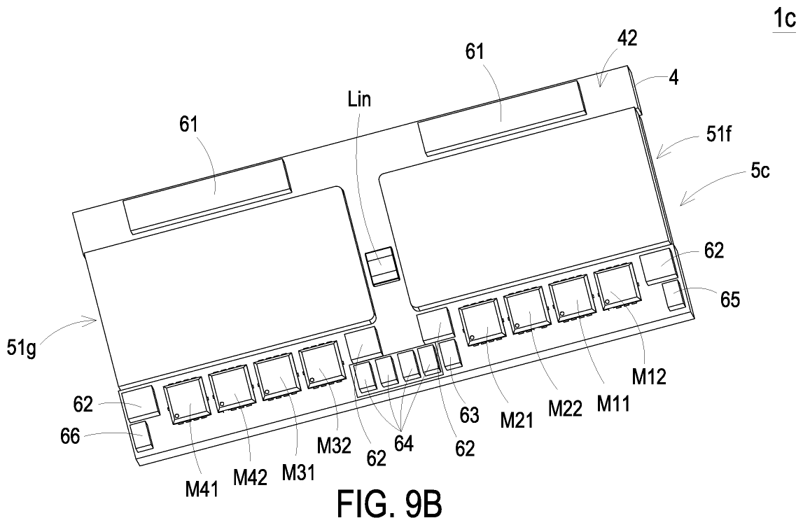

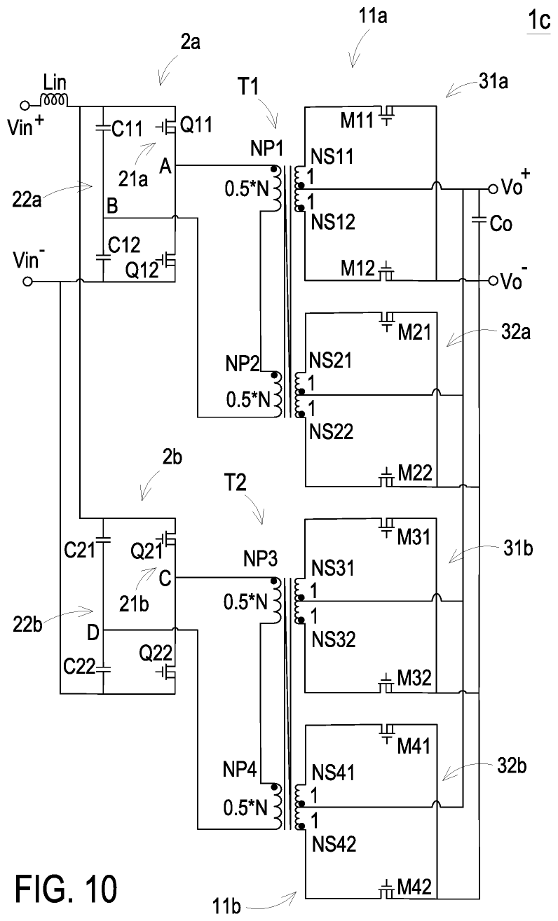

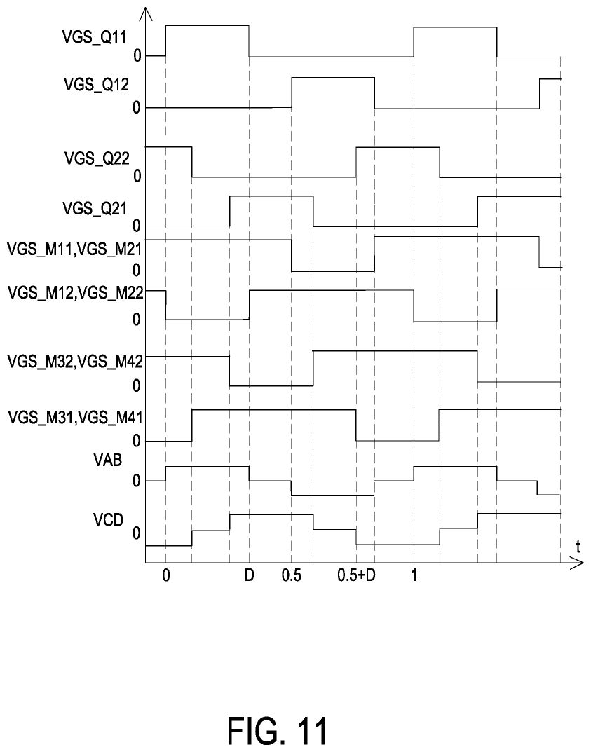

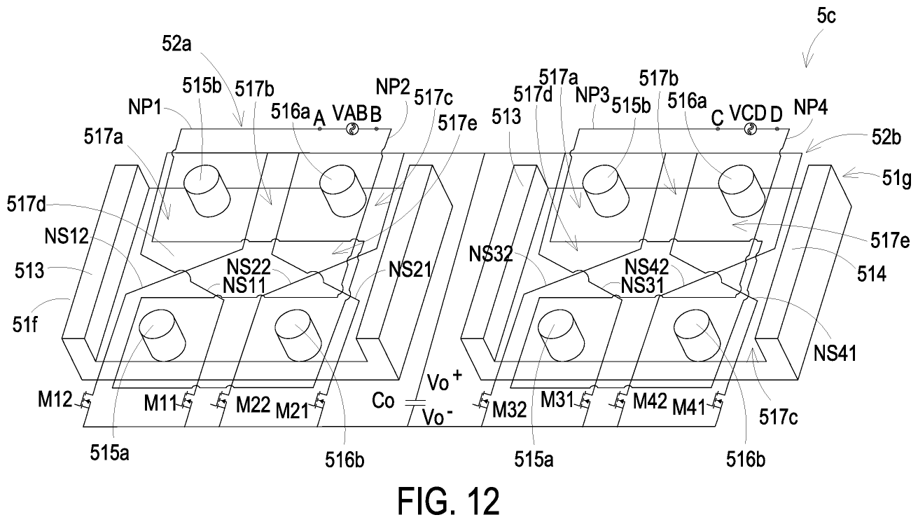

In some embodiments, in order to increase the output power, the power conversion module utilizes a plurality of basic power conversion units to increase the output current, thereby achieving the effect of increasing the output power. Please refer to FIGS. 9A, 9B, 10, 11 and 12. FIG. 9A is a schematic perspective view illustrating a power conversion module according to a fourth embodiment of the present disclosure, FIG. 9B is a schematic perspective view illustrating the power conversion module as shown in FIG. 9A and taken along another viewpoint, FIG. 10 is a schematic circuit diagram illustrating the circuitry topology of the power conversion module as shown in FIG. 9A, FIG. 11 is a schematic timing waveform diagram illustrating associated voltage signals of the power conversion module as shown in FIG. 9A, and FIG. 12 schematically illustrates the magnetic core assembly and the winding assembly in the magnetic device of the power conversion module as shown in FIG. 9A, in which the first magnetic cover is not shown.

As shown in FIG. 10, the electronic device 1c includes an input positive terminal Vin+, an input negative terminal Vin−, an output positive terminal Vo+, an output negative terminal Vo−, an input inductor Lin, a first switching circuit 2a, a second switching circuit 2b, a first transformer T1, a second transformer T2, a first rectifying circuit 31a, a second rectifying circuit 32a, a third rectifying circuit 31b, a fourth rectifying circuit 32b and an output capacitor Co. Preferably but not exclusively, the electronic device 1c is a power conversion module. The first switching circuit 2a, the transformer T1, the first rectifying circuit 31a and the second rectifying circuit 32a are collaboratively formed as a first basic power conversion unit 11a. The second switching circuit 2b, the transformer T2, the third rectifying circuit 31b and the fourth rectifying circuit 32b are collaboratively formed as a second basic power conversion unit 11b. The output terminal of the first basic power conversion unit 11a and the output terminal of the second basic power conversion unit 11b are electrically connected in parallel.

As shown in FIG. 10, the first switching circuit 2a includes a switch bridge arm 21a and a capacitor bridge arm 22a. The switch bridge arm 21a and the capacitor bridge arm 22a are collaboratively formed as a half-bridge circuit. The switch bridge arm 21a is electrically connected between the second terminal of the input inductor Lin and the input negative terminal Vin−. The switch bridge arm 21a includes an upper switch Q11 and a lower switch Q12. The upper switch Q11 and the lower switch Q12 are connected in series and connected with a midpoint A of the switch bridge arm 21a. The capacitor bridge arm 22a is electrically connected between the second terminal of the input inductor Lin and the input negative terminal Vin−. The capacitor bridge arm 22a and the switch bridge arm 21a are connected with each other in parallel. The capacitor bridge arm 22a includes a first capacitor C11 and a second capacitor C12. The first capacitor C11 and the second capacitor C12 are connected in series. Moreover, the first capacitor C11 and the second capacitor C12 are connected with a midpoint B of the capacitor bridge arm 22a.

The transformer T1 includes a primary winding assembly NP, a first secondary winding NS11, a second secondary winding NS12, a third secondary winding NS21 and a fourth secondary winding NS22. The primary winding assembly NP includes a first primary winding NP1 and a second primary winding NP2, which are serially connected between the midpoint A of the switch bridge arm 21a and the midpoint B of the capacitor bridge arm 22a. The first terminal of the first primary winding NP1 (i.e., the first terminal of the primary winding NP) is electrically connected with the midpoint A of the switch bridge arm 21a. The second terminal of the first primary winding NP1 is connected with the first terminal of the second primary winding NP2. The second terminal of the second primary winding NP2 (i.e., the second terminal of the primary winding assembly NP) is electrically connected with the midpoint B of the capacitor bridge arm 22a. The first terminal of the first primary winding NP1 and the first terminal of the second primary winding NP2 are common-polarity terminals (i.e., dotted terminals). That is, the polarity of the first terminal of the first primary winding NP1 and the polarity of the first terminal of the second primary winding NP2 are identical. The second terminal of the first primary winding NP1 and the second terminal of the second primary winding NP2 are common-polarity terminals (i.e., undotted terminals). That is, the polarity of the second terminal of the first primary winding NP1 and the polarity of the second terminal of the second primary winding NP2 are identical. The polarity of the second terminal of the first primary winding NP1 and the polarity of the first terminal of the second primary winding NP2 are opposite. The first primary winding NP1, the second primary winding NP2 and the first switching circuit 2a are collaboratively formed as a primary circuit of the first basic power conversion unit 11a.

In an embodiment, the primary winding assembly NP has N turns, wherein N is a multiple of the number of the primary windings of the primary winding assembly NP. Moreover, the first primary winding NP1 has 0.5N turns, and the second primary winding NP2 has 0.5N turns. For example, in case that the primary winding assembly NP includes 2 primary windings (i.e., the first primary winding NP1 and the second primary winding NP2), N is a multiple of 2.

The first secondary winding NS11 and the second secondary winding NS12 are connected in series. The first secondary winding NS11 and the second secondary winding NS12 are magnetically coupled with the first primary winding NP1. The second terminal of the first secondary winding NS11 and the second terminal of the second secondary winding NS12 are electrically connected with each other. Moreover, the second terminal of the first secondary winding NS11 and the second terminal of the second secondary winding NS12 are electrically connected with the output positive terminal Vo+. The polarity of the second terminal of the first secondary winding NS11 and the polarity of the second terminal of the second secondary winding NS12 are opposite. The polarity of the first terminal of the first secondary winding NS11 is opposite to the polarity of the first terminal (i.e., the dotted terminal) of the first primary winding NP1. The polarity of the first terminal of the second secondary winding NS12 is identical to the polarity of the first terminal (i.e., the dotted terminal) of the first primary winding NP1. In an embodiment, each of the first secondary winding NS11 and the second secondary winding NS12 has one turn.

The first rectifying circuit 31a includes a first rectifying switch M11 and a second rectifying switch M12. The drain terminal of the first rectifying switch M11 is electrically connected with the first terminal of the first secondary winding NS11. The drain terminal of the second rectifying switch M12 is electrically connected with the first terminal of the second secondary winding NS12. The source terminal of the first rectifying switch M11 and the source terminal of the second rectifying switch M12 are connected with each other. Moreover, the source terminal of the first rectifying switch M11 and the source terminal of the second rectifying switch M12 are electrically connected with the output negative terminal Vo−. The first secondary winding NS11, the second secondary winding NS12 and the first rectifying circuit 31 are collaboratively formed as a first secondary circuit of the first basic power conversion unit 11a.

The third secondary winding NS21 and the fourth secondary winding NS22 are connected in series. The third secondary winding NS21 and the fourth secondary winding NS22 are magnetically coupled with the second primary winding NP2. The second terminal of the third secondary winding NS21 and the second terminal of the fourth secondary winding NS22 are electrically connected with each other. Moreover, the second terminal of the third secondary winding NS21 and the second terminal of the fourth secondary winding NS22 are electrically connected with the output positive terminal Vo+. The polarity of the second terminal of the third secondary winding NS21 and the polarity of the second terminal of the fourth secondary winding NS22 are opposite. The polarity of the first terminal of the third secondary winding NS21 is opposite to the polarity of the first terminal (i.e., the dotted terminal) of the second primary winding NP2. The polarity of the first terminal of the fourth secondary winding NS22 is identical to the polarity of the first terminal (i.e., the dotted terminal) of the second primary winding NP2. In an embodiment, each of the third secondary winding NS21 and the fourth secondary winding NS22 has one turn.

The second rectifying circuit 32a includes a third rectifying switch M21 and a fourth rectifying switch M22. The drain terminal of the third rectifying switch M21 is electrically connected with the first terminal of the third secondary winding NS21. The drain terminal of the fourth rectifying switch M22 is electrically connected with the first terminal of the fourth secondary winding NS22. The source terminal of the third rectifying switch M21 and the source terminal of the fourth rectifying switch M22 are connected with each other. Moreover, the source terminal of the third rectifying switch M21 and the source terminal of the fourth rectifying switch M22 are electrically connected with the output negative terminal Vo−. The third secondary winding NS21, the fourth secondary winding NS22 and the second rectifying circuit 32a are collaboratively formed as a second secondary circuit of the first basic power conversion unit 11a.

Preferably but not exclusively, the first rectifying switch M11, the second rectifying switch M12, the third rectifying switch M21 and the fourth rectifying switch M22 are MOSFET switches, SiC switches, GaN switches or diode switches. The two terminals of the output capacitor Co are electrically connected with the output positive terminal Vo+ and the output negative terminal Vo−, respectively.

As shown in FIG. 10, the second switching circuit 2b includes a switch bridge arm 21b and a capacitor bridge arm 22b. The switch bridge arm 21b and the capacitor bridge arm 22b of the second switching circuit 2b are collaboratively formed as a half-bridge circuit. The switch bridge arm 21b is electrically connected between the second terminal of the input inductor Lin and the input negative terminal Vin−. The switch bridge arm 21b includes an upper switch Q21 and a lower switch Q22. The upper switch Q21 and the lower switch Q22 are connected in series and connected with a midpoint C of the switch bridge arm 21b. The capacitor bridge arm 22b is electrically connected between the second terminal of the input inductor Lin and the input negative terminal Vin−. The capacitor bridge arm 22b and the switch bridge arm 21b are connected with each other in parallel. The capacitor bridge arm 22b includes a first capacitor C21 and a second capacitor C22. The first capacitor C21 and the second capacitor C22 are connected in series. Moreover, the first capacitor C21 and the second capacitor C22 are connected with a midpoint D of the capacitor bridge arm 22b.

The second transformer T2 includes a primary winding assembly NP, a fifth secondary winding NS31, a sixth secondary winding NS32, a seven secondary winding NS41 and an eighth secondary winding NS42. The primary winding assembly NP includes a third primary winding NP3 and a fourth primary winding NP4, which are serially connected between the midpoint C of the switch bridge arm 21b and the midpoint D of the capacitor bridge arm 22b. The first terminal of the third primary winding NP3 (i.e., the first terminal of the primary winding NP) is electrically connected with the midpoint C of the switch bridge arm 21b. The second terminal of the third primary winding NP3 is connected with the first terminal of the fourth primary winding NP4. The second terminal of the fourth winding primary winding NP4 (i.e., the second terminal of the primary winding assembly NP) is electrically connected with the midpoint D of the capacitor bridge arm 22b. The first terminal of the third primary winding NP3 and the first terminal of the fourth primary winding NP4 are common-polarity terminals (i.e., dotted terminals). That is, the polarity of the first terminal of the third primary winding NP3 and the polarity of the first terminal of the fourth primary winding NP4 are identical. The second terminal of the third primary winding NP3 and the second terminal of the fourth primary winding NP4 are common-polarity terminals (i.e., undotted terminals). That is, the polarity of the second terminal of the third primary winding NP3 and the polarity of the second terminal of the fourth primary winding NP4 are identical. The polarity of the second terminal of the third primary winding NP3 and the polarity of the first terminal of the fourth primary winding NP4 are opposite. The third primary winding NP3, the fourth primary winding NP4 and the second switching circuit 2b are collaboratively formed as a primary circuit of the second basic power conversion unit 11b.

In an embodiment, the primary winding assembly NP has N turns, wherein N is a multiple of the number of the primary windings of the primary winding assembly NP. Moreover, the third primary winding NP3 has 0.5N turns, and the fourth primary winding NP4 has 0.5N turns. For example, in case that the primary winding assembly NP includes 2 primary windings (i.e., the third primary winding NP3 and the fourth primary winding NP4), N is a multiple of 2.

The fifth secondary winding NS31 and the sixth secondary winding NS32 are connected in series. The fifth secondary winding NS31 and the sixth secondary winding NS32 are magnetically coupled with the third primary winding NP3. The second terminal of the fifth secondary winding NS31 and the second terminal of the sixth secondary winding NS32 are electrically connected with each other. Moreover, the second terminal of the fifth secondary winding NS31 and the second terminal of the sixth secondary winding NS32 are electrically connected with the output positive terminal Vo+. The polarity of the second terminal of the fifth secondary winding NS31 and the polarity of the second terminal of the sixth secondary winding NS32 are opposite. The polarity of the first terminal of the fifth secondary winding NS31 is opposite to the polarity of the first terminal (i.e., the dotted terminal) of the third primary winding NP3. The polarity of the first terminal of the sixth secondary winding NS32 is identical to the polarity of the first terminal (i.e., the dotted terminal) of the third primary winding NP3. In an embodiment, each of the fifth secondary winding NS31 and the sixth secondary winding NS32 has one turn.

The third rectifying circuit 31b includes a fifth rectifying switch M31 and a sixth rectifying switch M32. The drain terminal of the fifth rectifying switch M31 is electrically connected with the first terminal of the fifth secondary winding NS31. The drain terminal of the sixth rectifying switch M32 is electrically connected with the first terminal of the sixth secondary winding NS32. The source terminal of the fifth rectifying switch M31 and the source terminal of the sixth rectifying switch M32 are connected with each other. Moreover, the source terminal of the fifth rectifying switch M31 and the source terminal of the sixth rectifying switch M32 are electrically connected with the output negative terminal Vo−. The fifth secondary winding NS31, the sixth secondary winding NS32 and the third rectifying circuit 31b are collaboratively formed as a first secondary circuit of the second basic power conversion unit 11b.

The seventh secondary winding NS41 and the eighth secondary winding NS42 are connected in series. The seventh secondary winding NS41 and the eighth secondary winding NS42 are magnetically coupled with the fourth primary winding NP4. The second terminal of the seventh secondary winding NS41 and the second terminal of the eighth secondary winding NS42 are electrically connected with each other. Moreover, the second terminal of the seventh secondary winding NS41 and the second terminal of the eighth secondary winding NS42 are electrically connected with the output positive terminal Vo+. The polarity of the second terminal of the seventh secondary winding NS41 and the polarity of the second terminal of the eighth secondary winding NS42 are opposite. The polarity of the first terminal of the seventh secondary winding NS41 is opposite to the polarity of the first terminal (i.e., the dotted terminal) of the fourth primary winding NP4. The polarity of the first terminal of the eighth secondary winding NS42 is identical to the polarity of the first terminal (i.e., the dotted terminal) of the fourth primary winding NP4. In an embodiment, each of the seventh secondary winding NS41 and the eighth secondary winding NS42 has one turn.

The fourth rectifying circuit 32b includes a seventh rectifying switch M41 and an eighth rectifying switch M42. The drain terminal of the seventh rectifying switch M41 is electrically connected with the first terminal of the seven secondary winding NS41. The drain terminal of the eighth rectifying switch M42 is electrically connected with the first terminal of the eighth secondary winding NS42. The source terminal of the seventh rectifying switch M41 and the source terminal of the eighth rectifying switch M42 are connected with each other. Moreover, the source terminal of the seventh rectifying switch M41 and the source terminal of the eighth rectifying switch M42 are electrically connected with the output negative terminal Vo−. The seventh secondary winding NS41, the eighth secondary winding NS42 and the fourth rectifying circuit 32b are collaboratively formed as a second secondary circuit of the second basic power conversion unit 11b.

Preferably but not exclusively, the fifth rectifying switch M31, the sixth rectifying switch M32, the seventh rectifying switch M41 and the eighth rectifying switch M42 are MOSFET switches, SiC switches, GaN switches or diode switches. The two terminals of the output capacitor Co are electrically connected with the output positive terminal Vo+ and the output negative terminal Vo−, respectively.

In an embodiment, the power conversion module 1c further includes a plurality of driving circuits (not shown) and a control circuit 33. Preferably, the number of the driving circuits is equal to the number of the switches. For example, the power conversion module 1 includes twelve driving circuits. The twelve driving circuits are electrically connected with the upper switch Q11, Q21, the lower switch Q12, Q22, the first rectifying switch M11, the second rectifying switch M12, the third rectifying switch M21, the fourth rectifying switch M22, the fifth rectifying switch M31, the sixth rectifying switch M32, the seventh rectifying switch M41, the eighth rectifying switch M42, respectively. The control circuit 33 is electrically connected with the twelve driving circuits. The control circuit 33 generates twelve PWM signals. The driving circuit generates the driving signal to drive the corresponding switch according to each PWM signal. The on/off states of the switches are controlled according to the corresponding driving signals. Consequently, the input voltage Vin is decreased to the output voltage Vo. The operation of the power conversion module 1c will be described as follows by referring to the waveform diagram of the driving signals for driving the corresponding switches.

In FIG. 11, VGS_Q11 denotes the gate-source voltage of the upper switch Q11, VGS_Q12 denotes the gate-source voltage of the lower switch Q12, VGS_Q21 denotes the gate-source voltage of the upper switch Q21, VGS_Q22 denotes the gate-source voltage of the lower switch Q22, VGS_M11 denotes the gate-source voltage of the first rectifying switch M11, VGS_M12 denotes the gate-source voltage of the second rectifying switch M12, VGS_M21 denotes the gate-source voltage of the third rectifying switch M21, VGS_M22 denotes the gate-source voltage of the fourth rectifying switch M22, VGS_M31 denotes the gate-source voltage of the fifth rectifying switch M31, and VGS_M32 denotes the gate-source voltage of the sixth rectifying switch M32, VGS_M41 denotes the gate-source voltage of the seventh rectifying switch M41, VGS_M42 denotes the gate-source voltage of the eighth rectifying switch M42. Moreover, VAB is the voltage between the midpoint A of the switch bridge arm 21a and the midpoint B of the capacitor bridge arm 22a. That is, VAB is the terminal voltage between the first terminal of the first primary winding NP1 and the second terminal of the second primary winding NP2. VCD is the voltage between the midpoint C of the switch bridge arm 21b and the midpoint D of the capacitor bridge arm 22b. That is, VCD is the terminal voltage between the first terminal of the third primary winding NP3 and the second terminal of the fourth primary winding NP4.

Please refer to FIG. 11 again. The upper switch Q11 receives a first driving signal. The waveform of the first driving signal matches the gate-source voltage VGS_Q11 of the upper switch Q11. The lower switch Q12 receives a second driving signal. The waveform of the second driving signal matches the gate-source voltage VGS_Q12 of the lower switch Q12. The duty cycle of the first driving signal and the duty cycle of the second driving signal are equal. The phase difference between the first driving signal and the second driving signal is 180 degrees.

Each of the first rectifying switch M11 and the third rectifying switch M21 receives a third driving signal. The first rectifying switch M11 and the third rectifying switch M21 are controlled to be turned on and turned off synchronously according to the third driving signal. The waveform of the third driving signal matches the gate-source voltage VGS_M11 of the first rectifying switch M11 and the gate-source voltage VGS_M21 of the third rectifying switch M21. Consequently, the frequency and the phase of the terminal voltage across the two terminals of the first secondary winding NS11 and the frequency and the phase of the terminal voltage across the two terminals of the third secondary winding NS21 are identical. The third driving signal and the second driving signal are complementary to each other.

Each of the second rectifying switch M12 and the fourth rectifying switch M22 receives a fourth driving signal. The second rectifying switch M12 and the fourth rectifying switch M22 are controlled to be turned on and turned off synchronously according to the fourth driving signal. The waveform of the fourth driving signal matches the gate-source voltage VGS_M12 of the second rectifying switch M12 and the gate-source voltage VGS_M22 of the fourth rectifying switch M22. Consequently, the frequency and the phase of the terminal voltage across the two terminals of the second secondary winding NS12 and the frequency and the phase of the terminal voltage across the two terminals of the fourth secondary winding NS22 are identical. The fourth driving signal and the first driving signal are complementary to each other.

Please refer to FIG. 11. In an embodiment, the voltage between the midpoint A of the switch bridge arm 21a and the midpoint B of the capacitor bridge arm 22a is a three-level AC voltage. That is, the terminal voltage VAB has three voltage levels, including the positive input voltage (+Vin/2), 0 and the negative input voltage (−Vin/2). In another embodiment, the first capacitor C1 and the second capacitor C2 of the capacitor bridge arm 22a are replaced by switches. Under this circumstance, the first switching circuit 2a includes two switch bridge arms. The methods for driving the switches of the two switch bridge arms are not restricted as long as the voltage VAB has three voltage levels including the positive input voltage (+Vin/2), 0 and the negative input voltage (−Vin/2). In another embodiment, a blocking capacitor is disposed between the midpoint A of the switch bridge arm 21a and the midpoint B of the capacitor bridge arm 22a, or a current-sharing function is provided. Consequently, the DC current will not flow through the region between the midpoint A of the switch bridge arm 21a and the midpoint B of the capacitor bridge arm 22a.

Please refer to FIG. 11 again. The upper switch Q21 receives a fifth driving signal. The waveform of the fifth driving signal matches the gate-source voltage VGS_Q21 of the upper switch Q21. The lower switch Q22 receives a sixth driving signal. The waveform of the sixth driving signal matches the gate-source voltage VGS_Q22 of the lower switch Q22. The duty cycle of the fifth driving signal and the duty cycle of the sixth driving signal are equal. The phase difference between the fifth driving signal and the sixth driving signal is 180 degrees. The phase difference between the fifth driving signal and the first driving signal is 90 degrees, and the phase difference between the fifth driving signal and the second driving signal is 90 degrees. The phase difference between the sixth driving signal and the first driving signal is 90 degrees, and the phase difference between the sixth driving signal and the second driving signal is 90 degrees.

Each of the fifth rectifying switch M31 and the seventh rectifying switch M41 receives a seventh driving signal. The fifth rectifying switch M31 and the seventh rectifying switch M41 are controlled to be turned on and turned off synchronously according to the seventh driving signal. The waveform of the seventh driving signal matches the gate-source voltage VGS_M31 of the fifth rectifying switch M31 and the gate-source voltage VGS_M41 of the seventh rectifying switch M41. Consequently, the frequency and the phase of the terminal voltage across the two terminals of the fifth secondary winding NS31 and the frequency and the phase of the terminal voltage across the two terminals of the seventh secondary winding NS41 are identical. The seventh driving signal and the sixth driving signal are complementary to each other.

Each of the sixth rectifying switch M32 and the eighth rectifying switch M42 receives an eighth driving signal. The sixth rectifying switch M32 and the eighth rectifying switch M42 are controlled to be turned on and turned off synchronously according to the eighth driving signal. The waveform of the eighth driving signal matches the gate-source voltage VGS_M32 of the sixth rectifying switch M32 and the gate-source voltage VGS_M42 of the eighth rectifying switch M42. Consequently, the frequency and the phase of the terminal voltage across the two terminals of the sixth secondary winding NS32 and the frequency and the phase of the terminal voltage across the two terminals of the eighth secondary winding NS42 are identical. The eighth driving signal and the fifth driving signal are complementary to each other.

Please refer to FIG. 11. In an embodiment, the voltage between the midpoint C of the switch bridge arm 21b and the midpoint D of the capacitor bridge arm 22b is a three-level AC voltage. That is, the terminal voltage VCD has three voltage levels, including the positive input voltage (+Vin/2), 0 and the negative input voltage (−Vin/2).

Please refer to FIGS. 9A, 9B and 10. The power conversion module 1c is disposed on the system board (not shown). The power conversion module 1c includes a circuit board 4, a magnetic device 5c, the upper switch Q11, Q21, the lower switch Q12, Q22, the first capacitor C11, C21, the second capacitor C12, C22, and a plurality of rectifying switches M11, M12, M21, M22, M31, M32, M41, M42.

The circuit board 4 includes a first surface 41, a second surface 42 and a plurality of openings (not shown). The first surface 41 and the second surface 42 are opposed to each other. The arrangements of the plurality of openings are similar to that of the openings of the power conversion module 1 in the first embodiment, and the details thereof are not redundantly described hereinafter.

The magnetic device 5c includes a first magnetic core assembly 51f, a second magnetic core assembly 51g, a first winding assembly 52a and a second winding assembly 52b. The first magnetic core assembly 51f and the first winding assembly 52a form the first transformer T1 as shown in FIG. 10. The second magnetic core assembly 51g and the second winding assembly 52b form the second transformer T2 as shown in FIG. 10. The first magnetic core assembly 51f is located beside the second magnetic core assembly 51g. The structures of the first magnetic core assembly 51f and the second magnetic core assembly 51g are similar to that of the magnetic core assembly 51 as shown in FIG. 2, and the details thereof are not redundantly described hereinafter. In addition, the first winding assembly 52a and the second winding assembly 52b are disposed in the circuit board 4. The winding method of the first winding assembly 52a and the second winding assembly 52b will be described hereafter and referring to FIG. 12.

As shown in FIGS. 9A and 9B, the upper switches Q11, Q21, the lower switches Q12, Q22, the first capacitors C11, C21 and the second capacitors C12, C22 are disposed on the first surface 41 of the circuit board 41. The first capacitor C11 and the second capacitor C12 are located beside each other. The first capacitor C11 and the second capacitor C12 are located beside the second lateral side 51b of the first magnetic core assembly 51f when the first magnetic core assembly 51f is disposed on the circuit board 4. The first capacitor C21 and the second capacitor C22 are located beside each other. The first capacitor C21 and the second capacitor C22 are located beside the second lateral side 51b of the second magnetic core assembly 51g when the second magnetic core assembly 51g is disposed on the circuit board 4. The upper switch Q11, the lower switch Q12, the upper switch Q21 and the lower switch Q22 are sequentially disposed between the first capacitor C11 and the first capacitor C21.

The two first rectifying switches M11 are disposed on the first surface 41 and the second surface 42 of the circuit board 4, respectively. Preferably, the two first rectifying switches M11 are in mirror symmetry with respect to the circuit board 4. The two first rectifying switches M11 are located beside the first lateral side 51a of the first magnetic core assembly 51f when the first magnetic core assembly 51f is disposed on the circuit board 4. The two first rectifying switches M11 are connected with each other in parallel through corresponding traces (not shown) in the circuit board 4. Similarly, two second rectifying switches M12 are disposed on the first surface 41 and the second surface 42 of the circuit board 4, respectively. Preferably, the two second rectifying switches M12 are in mirror symmetry with respect to the circuit board 4. The two second rectifying switches M12 are located beside the first lateral side 51a of the first magnetic core assembly 51f when the first magnetic core assembly 51f is disposed on the circuit board 4. The two second rectifying switches M12 are connected with each other in parallel through corresponding traces (not shown) in the circuit board 4. Similarly, two third rectifying switches M21 are disposed on the first surface 41 and the second surface 42 of the circuit board 4, respectively. The two third rectifying switches M21 are located beside the first lateral side 51a of the first magnetic core assembly 51f when the first magnetic core assembly 51f is disposed on the circuit board 4. The two third rectifying switches M21 are connected with each other in parallel through corresponding traces (not shown) in the circuit board 4. Two fourth rectifying switches M22 are disposed on the first surface 41 and the second surface 42 of the circuit board 4, respectively. Preferably, the two fourth rectifying switches M22 are in mirror symmetry with respect to the circuit board 4. The two fourth rectifying switches M22 are located beside the first lateral side 51a of the first magnetic core assembly 51f when the first magnetic core assembly 51f is disposed on the circuit board 4. The two fourth rectifying switches M22 are connected with each other in parallel through corresponding traces (not shown) in the circuit board 4.

In this embodiment, the second rectifying switch M12, the first rectifying switch M11, the fourth rectifying switch M22 and the third rectifying switch M21 are disposed sequentially. The arrangement direction of the second rectifying switch M12, the first rectifying switch M11, the fourth rectifying switch M22 and the third rectifying switch M21 is parallel to the first lateral side 51a of the first magnetic core assembly 51f.

The two fifth rectifying switches M31 are disposed on the first surface 41 and the second surface 42 of the circuit board 4, respectively. Preferably, the two fifth rectifying switches M31 are in mirror symmetry with respect to the circuit board 4. The two fifth rectifying switches M31 are located beside the first lateral side 51a of the second magnetic core assembly 51g when the second magnetic core assembly 51g is disposed on the circuit board 4. The two fifth rectifying switches M31 are connected with each other in parallel through corresponding traces (not shown) in the circuit board 4. Similarly, two sixth rectifying switches M32 are disposed on the first surface 41 and the second surface 42 of the circuit board 4, respectively. The two sixth rectifying switches M32 are located beside the first lateral side 51a of the second magnetic core assembly 51g when the second magnetic core assembly 51g is disposed on the circuit board 4. The two sixth rectifying switches M32 are connected with each other in parallel through corresponding traces (not shown) in the circuit board 4. Similarly, two seventh rectifying switches M41 are disposed on the first surface 41 and the second surface 42 of the circuit board 4, respectively. The two seventh rectifying switches M41 are located beside the first lateral side 51a of the second magnetic core assembly 51g when the second magnetic core assembly 51g is disposed on the circuit board 4. The two seventh rectifying switches M41 are connected with each other in parallel through corresponding traces (not shown) in the circuit board 4. Two eighth rectifying switches M42 are disposed on the first surface 41 and the second surface 42 of the circuit board 4, respectively. The two eighth rectifying switches M42 are located beside the first lateral side 51a of the second magnetic core assembly 51g when the second magnetic core assembly 51g is disposed on the circuit board 4. The two eighth rectifying switches M42 are connected with each other in parallel through corresponding traces (not shown) in the circuit board 4.

In this embodiment, the sixth rectifying switch M32, the fifth rectifying switch M31, the eighth rectifying switch M42 and the seventh rectifying switch M41 are disposed sequentially. The second rectifying switch M12, the first rectifying switch M11, the fourth rectifying switch M22, the third rectifying switch M21, the sixth rectifying switch M32, the fifth rectifying switch M31, the eighth rectifying switch M42 and the seventh rectifying switch M41 are arranged sequentially along the same direction. In an embodiment, two rectifying switches disposed correspondingly on the first surface 41 and the second surface 42 of the circuit board 4 are partially overlapped with each other along the vertical direction. For example, the first rectifying switch M11 on the first surface 41 of the circuit board 4 and the first rectifying switch M11 on the second surface 42 of the circuit board 4 are partially overlapped with each other along the vertical direction. Similarly, the arrangements of other rectifying switches are similar to that as described above, and are not redundantly described hereinafter. The control circuit 33 is disposed on the first surface 41 of the circuit board 4 and located between the third rectifying switch M21 and the sixth rectifying switch M32.

Please refer to FIG. 9B again. The power conversion module 1c further includes two positive output pins 61, four negative output pins 62, a positive input pin 63, a plurality of signal pins 64 and an input inductor Lin. The positive output pins 61 are used as the output positive terminal Vo+ as shown in FIG. 10. The positive output pins 61 are disposed on the second surface 42 of the circuit board 4. The two positive output pins 61 are located beside the second lateral side 51b of the first magnetic core assembly 51f and the second lateral side 51b of the second magnetic core assembly 51g when the first magnetic core assembly 51f and the second magnetic core assembly 51g are disposed on the circuit board 4. The fourth negative output pins 62 are used as the output negative terminal Vo− as shown in FIG. 10. The four negative output pins 62 are disposed on the second surface 42 of the circuit board 4. Two of the four negative output pins 62 are located beside the first lateral side 51a of the first magnetic core assembly 51f when the first magnetic core assembly 51f is disposed on the circuit board 4, and the other two of the four negative output pins 62 are located beside the first lateral side 51a of the second magnetic core assembly 51g when the second magnetic core assembly 51g is disposed on the circuit board 4. The second rectifying switch M12, the first rectifying switch M11, the fourth rectifying switch M22 and the third rectifying switch M21 are located between the two of the four negative output pins 62. The sixth rectifying switch M32, the fifth rectifying switch M31, the eighth rectifying switch M42 and the seventh rectifying switch M41 are located between the other two of the four negative output pins 62. The positive input pin 63 is used as the input positive terminal Vin+ as shown in FIG. 10. The positive input pin 63 is disposed on the second surface 42 of the circuit board 4. The plurality of signal pins 64 are used for transferring control signals (e.g., the PWM signals for controlling the rectifying switches), the detection signals, the temperature signals or associated signals. Consequently, the purpose of homogenizing the currents of different modules, synchronizing the PWM signals of different modules or communicating different modules can be achieved. The plurality of signal pins 64 are disposed on the second surface 42 of the circuit board 4. The plurality of signal pins 64 and the positive input pin 63 are disposed in a line. The plurality of signal pins 64 are located between the third rectifying switch M21 and the sixth rectifying switch M32. The input inductor Lin is disposed on the second surface 42 of the circuit board 4. In addition, the input inductor Lin is located between the first magnetic core assembly 51f and the second magnetic core assembly 51g when the first magnetic core assembly 51f and the second magnetic core assembly 51g are disposed on the circuit board 4. In an embodiment, the power conversion module 1c further includes an auxiliary power pin 65. The auxiliary power pin 65 is used to provide auxiliary power to the power conversion module 1c. The auxiliary power pin 65 is disposed on the second surface 42 of the circuit board 4. In addition, the auxiliary power pin 65 is located beside one of the negative output pins 62. In other embodiment, the power conversion module 1c further includes a control signal pin 66 disposed on the second surface 42 of the circuit board 4. The control signal pin 66 is located beside the other of the negative output pins 62. The arrangements of the auxiliary power pin 65 and the control signal pin 66 are not limited to the above-mentioned embodiment, and are adjusted according to the practical requirements.

The method of winding the first winding assembly 52a around the first magnetic core assembly 51f and the method of winding the second winding assembly 52b around the second magnetic core assembly 51g will be described with reference to FIG. 12. For succinctness, the first magnetic covers 511 of the first magnetic core assembly 51f and the second magnetic core assembly 51g are not shown. As shown in FIG. 12, the first winding assembly 52a includes the primary winding assembly NP (i.e., the first primary winding NP1 and the second primary winding NP2) and the four coupled windings (i.e., the first secondary winding NS11, the second secondary winding NS12, the third secondary winding NS21 and the fourth secondary winding NS22). The winding methods of the first primary winding NP1, the second primary winding NP2, the first secondary winding NS11, the second secondary winding NS12, the third secondary winding NS21 and the fourth secondary winding NS22 are similar to those of FIG. 7, and not redundantly described herein.

The second winding assembly 52b includes the primary winding assembly NP (i.e., the third primary winding NP3 and the fourth primary winding NP4) and the four coupled windings (i.e., the fifth secondary winding NS31, the sixth secondary winding NS32, the seventh secondary winding NS41 and the eighth secondary winding NS42). The winding methods of the third primary winding NP3, the fourth primary winding NP4, the fifth secondary winding NS31, the sixth secondary winding NS32, the seventh secondary winding NS41 and the eighth secondary winding NS42 are similar to the winding methods of the first primary winding NP1, the second primary winding NP2, the first secondary winding NS11, the second secondary winding NS12, the third secondary winding NS21 and the fourth secondary winding NS22 of FIG. 7, and not redundantly described herein.

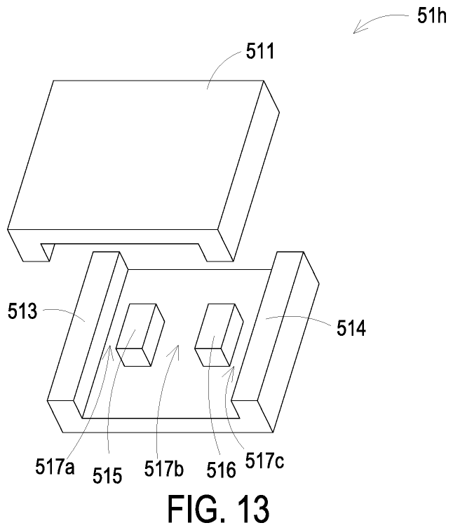

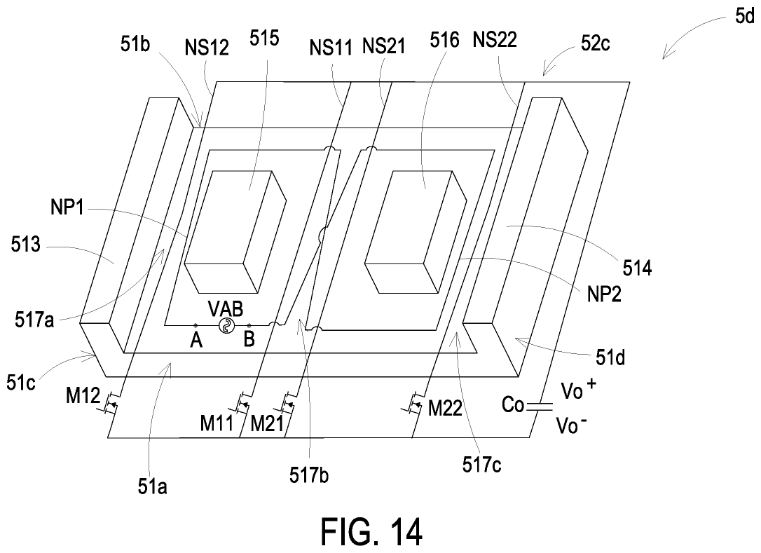

As mentioned in the above embodiment, the first inner magnetic leg group includes two independent inner magnetic legs, and the second inner magnetic leg group includes two independent inner magnetic legs. In some other embodiments, the first inner magnetic leg group and the second inner magnetic leg group include a single inner magnetic leg, respectively. Please refer to FIGS. 13 and 14. FIG. 13 is a schematic perspective view illustrating a power conversion module according to a fifth embodiment of the present disclosure, and FIG. 14 schematically illustrates the magnetic core assembly and the winding assembly in the magnetic device of the power conversion module as shown in FIG. 13, in which the first magnetic cover is not shown. In the embodiment, the structure of magnetic device 5d is similar to that of the magnetic device 5 as shown in FIG. 2. In comparison with the magnetic device 5 of the above embodiment, the first inner leg group 515 and the second inner magnetic leg group 516 of the magnetic core assembly 51h of the magnetic device 5d include a single inner magnetic leg, respectively. As shown in FIG. 13, a first channel 517a is formed between the first inner magnetic leg group 515 and the first outer magnetic leg 513. A second channel 517b is formed between the second inner magnetic leg group 516 and the first inner magnetic leg group 515. A third channel 517c is formed between the second inner magnetic leg group 516 and the second outer magnetic leg 514.

The method of winding the winding assembly 52c around the magnetic core assembly 51h will be described with reference to FIG. 14. As shown in FIG. 14, the winding assembly 52c includes the primary winding assembly NP (i.e., the first primary winding NP1 and the second primary winding NP2) and the four coupled windings (i.e., the first secondary winding NS11, the second secondary winding NS12, the third secondary winding NS21 and the fourth secondary winding NS22).

The first terminal and the second terminal of the primary winding NP are located beside one side of the first inner magnetic leg group 515 near to the first lateral side 51a of the magnetic core assembly 51h. The primary winding from the first terminal to the second terminal is wound around the first inner magnetic leg group 515 and the second inner magnetic leg group 516. The direction of winding portion of the primary winding NP around the first inner magnetic leg group 515 and the direction of winding the other portion of the primary winding NP around the second inner magnetic leg group 516 are opposed. The primary winding NP from the first terminal to the second terminal is sequentially transferred through the first channel 517a, one side of the first inner magnetic leg group 515 near to the second lateral side 51b of the magnetic core assembly 51h, the second channel 517b, one side of the second inner magnetic leg group 516 near to the first lateral side 51a of the magnetic core assembly 51h, the third channel 517c, one side of the second inner magnetic leg group 516 near to the second lateral side 51b of the magnetic core assembly 51h and the second channel 517b. At least two segments of the primary winding NP in the second channel 517b are crossed with each other, portion of the primary winding assembly NP is wound around the first inner magnetic leg group 515, and the other portion of the primary winding assembly Np is wound around the second inner magnetic leg group 516. The portion of the primary winding assembly NP wound around the first inner magnetic leg group 515 is the first primary winding NP1. The other portion of the primary winding assembly NP wound around the second inner magnetic leg group 516 is the second primary winding NP2. The turn number of the primary winding assembly NP wound around the first inner magnetic leg group 515 and the turn number of the primary winding assembly NP wound around the second inner magnetic leg group 516 are identical. The primary winding assembly NP is wound around each of the first inner magnetic leg group 515 and the second inner magnetic leg group 516 for one turn.

It is noted that the turn number of the primary winding assembly NP wound around each of the first inner magnetic leg group 515 and the second inner magnetic leg group 516 is not restricted. In another embodiment, the primary winding assembly NP is wound around each of the first inner magnetic leg group 515 and the second inner magnetic leg group 516 for more than one turn (e.g., X turns). For example, the primary winding assembly NP is sequentially wound around the first inner magnetic leg group 515 and the second inner magnetic leg group 516 for one turn, and then the above process is performed for X times to form X turns. Alternatively, the primary winding assembly NP is wound around the first inner magnetic leg group 515 for X turns, and then the primary winding assembly NP is wound around the second inner magnetic leg group 516 for X turns, so as to form X turns around the first inner magnetic leg group 515 and the second inner magnetic leg group 516.

In the embodiment, the first terminal of the primary winding assembly NP is connected with the midpoint A of the switch bridge arm 21 as shown in FIG. 3 and thus connected with the first switching circuit 2. The second terminal of the primary winding assembly NP is connected with the midpoint B of the capacitor bridge arm 22 and thus connected with the switching circuit 2. That is, the voltage across the first terminal and the second terminal of the primary winding assembly NP is equal to VAB.

The first terminal of the first secondary winding NS11 is connected with the drain terminal of the first rectifying switch M11. The first terminal of the first secondary winding NS11 is located near the first lateral side 51a and the second channel 517b of the magnetic core assembly 51h. The second terminal of the first secondary winding NS11 is located near the second lateral side 51b and the second channel 517a of the magnetic core assembly 51h. The first secondary winding NS11 is transferred through the second channel 517b. The first terminal of the second secondary winding NS12 is connected with the drain terminal of the second rectifying switch M12. The first terminal of the second secondary winding NS12 is located beside the first lateral side 51a and the first channel 517a of the magnetic core assembly 51h. The second terminal of the second secondary winding NS12 is located beside the second lateral side 51b and the first channel 517a of the magnetic core assembly 51h. The second secondary winding NS12 is transferred through the first channel 517a.

The first terminal of the third secondary winding NS21 is connected with the drain terminal of the third rectifying switch M21. The first terminal of the third secondary winding NS21 is located near the first lateral side 51a and the second channel 517b of the magnetic core assembly 51h. The second terminal of the third secondary winding NS21 is located near the second lateral side 51b and the second channel 517b of the magnetic core assembly 51h. The third secondary winding NS21 is transferred through the second channel 517b. The first terminal of the fourth secondary winding NS22 is connected with the drain terminal of the fourth rectifying switch M22. The first terminal of the fourth secondary winding NS22 is located near the first lateral side 51a and the third channel 517c of the magnetic core assembly 51h. The second terminal of the fourth secondary winding NS22 is located near the second lateral side 51b and the third channel 517c of the magnetic core assembly 51h. The fourth secondary winding NS22 is transferred through the third channel 517c. The second terminal of the second secondary winding N12, the second terminal of the first secondary winding NS11, the second terminal of the fourth secondary winding NS22 and the second terminal of the third secondary winding NS21 are connected together and located beside one side of the second inner magnetic leg group 516 near to the second lateral side 51b of the magnetic core assembly 51h. The distribution of the equivalent magnetic resistance of the magnetic device 5d is similar to that of the magnetic device of FIG. 6A, and the magnetic fluxes generated by the magnetic device 5d is similar to that of the magnetic device 5 of the first embodiment, and are not redundantly described hereinafter.

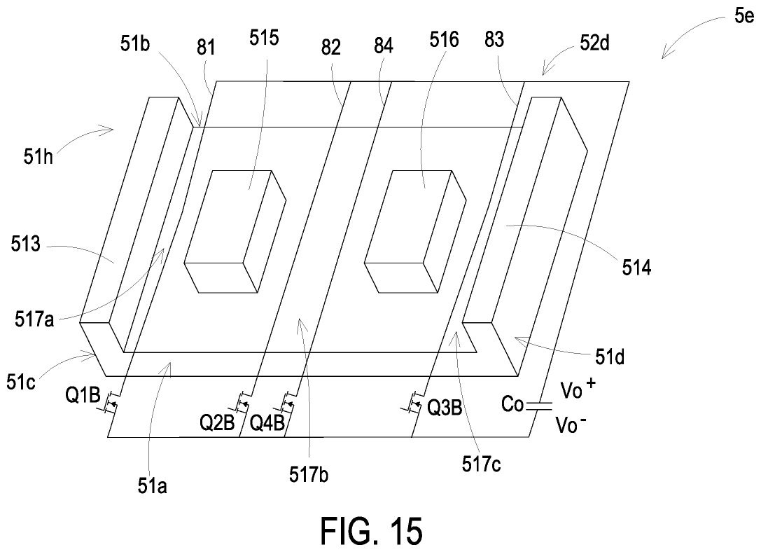

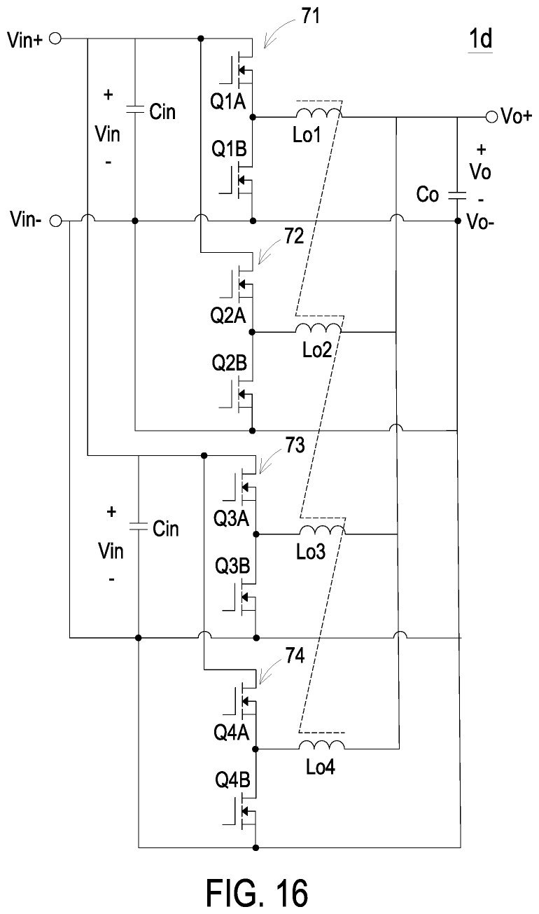

Please refer to FIGS. 15 and 16. FIG. 15 is a schematic perspective view illustrating a power conversion module according to a sixth embodiment of the present disclosure, and FIG. 16 is a schematic circuit diagram illustrating the circuitry topology of the power conversion module as shown in FIG. 15. As shown in FIG. 16, The power conversion module 1d includes an input positive terminal Vin+, an input negative terminal Vin−, an output positive terminal Vo+, an output negative terminal Vo−, an input capacitor Cin, a first buck converter 71, a second buck converter 72, a third buck converter 73, a fourth buck converter 74 and an output capacitor Co. The input capacitor Cin is electrically connected between the input positive terminal Vin+ and the input negative terminal Vin−. The input terminal of the first buck converter 71, the input terminal of the second buck converter 72, the input terminal of the third buck converter 73 and the input terminal of the fourth buck converter 74 are connected in parallel between the input positive terminal Vin+ and the input negative terminal Vin−. The output terminal of the first buck converter 71, the output terminal of the second buck converter 72, the output terminal of the third buck converter 73 and the output terminal of the fourth buck converter 74 are connected in parallel between the output positive terminal Vo+ and the output negative terminal Vo−. The input negative terminal Vin− and the output positive terminal Vo+ are directly connected with each other.

The first buck converter 71 includes an upper switch Q1A, a lower switch Q1B and a first coupled inductor Lo1. The upper switch Q1A and the lower switch Q1B are connected in series and form a switch bridge arm. The first coupled inductor Lo1 is electrically connected to a midpoint of the switch bridge arm formed by the upper switch Q1A and the lower switch Q1B. The second buck converter 72 includes an upper switch Q2A, a lower switch Q2B and a second coupled inductor Lo2. The upper switch Q2A and the lower switch Q2B are connected in series and form a switch bridge arm. The second coupled inductor Lo2 is electrically connected to a midpoint of the switch bridge arm formed by the upper switch Q2A and the lower switch Q2B. The third buck converter 73 includes an upper switch Q3A, a lower switch Q3B and a third coupled inductor Lo3. The upper switch Q3A and the lower switch Q3B are connected in series and form a switch bridge arm. The third coupled inductor Lo3 is electrically connected to a midpoint of the switch bridge arm formed by the upper switch Q3A and the lower switch Q3B. The fourth buck converter 74 includes an upper switch Q4A, a lower switch Q4B and a fourth coupled inductor Lo4. The upper switch Q4A and the lower switch Q4B are connected in series and form a switch bridge arm. The fourth coupled inductor Lo4 is electrically connected to a midpoint of the switch bridge arm formed by the upper switch Q4A and the lower switch Q4B. In the embodiment, the frequency and the phase of the driving signal received by the upper switch Q1A of the first buck converter 71 and the frequency and the phase of the driving signal received by the upper switch Q3A of the third buck converter 73 are identical. The above driving signal is denoted as the first driving signal. The frequency and the phase of the driving signal received by the upper switch Q2A of the second buck converter 72 and the frequency and the phase of the driving signal received by the upper switch Q4A of the fourth buck converter 74 are identical. The above driving signal is denoted as the second driving signal. The phase difference between the first driving signal and the second driving signal is 180 degrees.

The first coupled inductor Lo1, the second coupled inductor Lo2, the third coupled inductor Lo3 and the fourth coupled inductor Lo4 are magnetically coupled with each other to form a magnetic device 5e. In the embodiment, the method of winding the winding assembly 52d around the magnetic core assembly 51h is described as referring to FIG. 15. The structure of the magnetic core assembly 51h is similar to that of the magnetic core assembly 51h of FIG. 13, and are not redundantly described hereinafter. FIG. 15 only shows the lower switch of each buck converter, but it is obvious that the upper switch of each buck converter can be disposed according to the practical requirements. The lower switch Q1B of the first buck converter 71, the lower switch Q2B of the second buck converter 72, the lower switch Q3B of the third buck converter 73 and the lower switch Q4B of the fourth buck converter 74 are sequentially arranged and located beside the first lateral side 51a of the magnetic core assembly 51h.

In the embodiment, the winding assembly 52d includes a first coupled winding 81, a second coupled winding 82, a third coupled winding 83 and a fourth coupled winding 84. The first terminal of the first coupled winding 81 is electrically connected to the drain terminal of the lower switch Q1B of the first buck converter 71, and located beside the first lateral side 51a and the first channel 517a of the magnetic core assembly 51h. The second terminal of the first coupled winding 81 is located beside the second lateral side 51b and the first channel 517a of the magnetic core assembly 51h. The first coupled winding 81 is transferred through the first channel 517a. The first terminal of the second coupled winding 82 is electrically connected to the drain terminal of the lower switch Q2B of the second buck converter 72, and located beside the first lateral side 51a and the second channel 517b of the magnetic core assembly 51h. The second terminal of the second coupled winding 82 is located beside the second lateral side 51b and the second channel 517b of the magnetic core assembly 51h. The second coupled winding 82 is transferred through the second channel 517b. The first terminal of the third coupled winding 83 is electrically connected to the drain terminal of the lower switch Q3B of the third buck converter 73, and located beside the first lateral side 51a and the third channel 517c of the magnetic core assembly 51h. The second terminal of the third coupled winding 83 is located beside the second lateral side 51b and the third channel 517c of the magnetic core assembly 51h. The third coupled winding 83 is transferred through the third channel 517c. The first terminal of the fourth coupled winding 84 is electrically connected to the drain terminal of the lower switch Q4B of the fourth buck converter 74, and located beside the first lateral side 51a and the second channel 517b of the magnetic core assembly 51h. The second terminal of the fourth coupled winding 84 is located beside the second lateral side 51b and the second channel 517b of the magnetic core assembly 51h. The fourth coupled winding 84 is transferred through the second channel 517b. The source terminal of the lower switch Q1B, the source terminal of the lower switch Q2B, the source terminal of the lower switch Q3B and the source terminal of the lower switch Q4B are connected together and located beside one side of the second inner magnetic leg group 516 near to the first lateral side 51a of the magnetic core assembly 51h. The source terminal of the lower switch Q1B, the source terminal of the lower switch Q2B, the source terminal of the lower switch Q3B and the source terminal of the lower switch Q4B are electrically connected to the output negative terminal Vo−. The second terminal of the first coupled winding 81, the second terminal of the second coupled winding 82, the second terminal of the third coupled winding 83 and the second terminal of the fourth coupled winding 84 are electrically connected together and located beside one side of the second inner magnetic leg group 516 near to the second lateral side 51b of the magnetic core assembly 51h. The second terminal of the first coupled winding 81, the second terminal of the second coupled winding 82, the second terminal of the third coupled winding 83 and the second terminal of the fourth coupled winding 84 are electrically connected to the output positive terminal Vo+. The first coupled winding 81 is wound around the magnetic core assembly 51h to form the first coupled inductor Lo1 as show in FIG. 14. The second coupled winding 82 is wound around the magnetic core assembly 51h to form the second coupled inductor Lo2 as show in FIG. 14. The third coupled winding 83 is wound around the magnetic core assembly 51h to form the third coupled inductor Lo3 as show in FIG. 14. The fourth coupled winding 84 is wound around the magnetic core assembly 51h to form the fourth coupled inductor Lo4 as show in FIG. 14. The first terminal and the second terminal of the output capacitor Co are electrically connected to the output positive terminal Vo+ and the output negative terminal Vo−, respectively.

The distribution of the equivalent magnetic resistance of the magnetic device 5d is similar to that of the magnetic device of FIG. 6A, and the magnetic fluxes generated by the magnetic device 5d is similar to that of the magnetic device 5 of the first embodiment, and are not redundantly described hereinafter. In the embodiment, the power conversion module 1d utilizes four coupled winding and the magnetic core assembly 51h to achieve the filtering function of the four output inductors. The magnetic device 5e is highly integrated and small in size. The winding assembly 52d is wound in such a way that the paths of the four coupled windings are short, the parasitic resistance is small and the conduction loss is low. In addition, the output current of the power conversion module 1d flows to the four coupled windings, so that the power conversion module 1d has lower loss and smaller thermal resistance. It is also possible to adjust the ripple current and the saturation current of the first coupled inductor Lo1, the second coupled inductor Lo2, the third coupled inductor Lo3 and the fourth coupled inductor Lo4 by adjusting the magnetic resistance Rm.

In order to make the production simple, the magnetic core assembly of the above embodiments can also be made of magnetic powder materials with low permeability and high magnetic resistance. It will lead to fail to satisfy the magnetic resistance distribution relationship of the above embodiments, so that a small amount of DC magnetic flux in the magnetic leg is generated. Consequently, the ripple current is slightly larger. However, it can achieve the advantages of ease of production and cost reduction.

From the above descriptions, the present disclosure provides the power conversion module. The magnetic core assembly and the winding assembly in the magnetic device of the power conversion module are specially designed. Consequently, the voltage reduction function of the transformer is achieved, and the multi-phase output inductor with large inductance is obtained. That is, the power conversion module 1 with the single-stage converter can achieve the voltage reduction function and the filtering function. In comparison with the conventional power conversion module with two stage converters, the magnetic device of the power conversion module of the present disclosure has reduced volume and increased integration. Consequently, the output ripple is low, the volume is small, the efficiency is high, and the application is expanded. Moreover, each secondary winding of the winding assembly is transferred through corresponding channels of the magnetic core assembly. Consequently, the voltage reduction function and the filtering function are achieved. In comparison with the arrangement of the secondary windings in the conventional power conversion module, the secondary winding of the winding assembly of the magnetic device of the present disclosure has the shorter connection path, the lower parasitic resistance and lower conduction losses. Moreover, the magnetic device of the power conversion module of the present disclosure includes four secondary windings. The overall output current is distributed to the four secondary windings. Consequently, the power loss is low, and the thermal resistance is low. The two primary windings of the winding assembly of the magnetic device are connected with each other in series and coupled with the four secondary windings. The input current of the primary windings is low. Consequently, the current-sharing efficacy between the first secondary winding and the second secondary winding and the current-sharing efficacy between the third secondary winding and the fourth secondary winding are enhanced. Consequently, the power conversion module of the present disclosure provides a larger output current, a larger output inductance, a smaller ripple current, a smaller volume, a higher power density and a higher efficiency.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A magnetic device, comprising:
a magnetic core assembly comprising:
a first magnetic cover;
a second magnetic cover opposed to the first magnetic cover;
a first outer magnetic leg disposed between a first end of the first magnetic cover and a first end of the second magnetic cover;
a second outer magnetic leg disposed between a second end of the first magnetic cover and a second end of the second magnetic cover;
a first inner magnetic leg group disposed between the first magnetic cover and the second magnetic cover, and between the first outer magnetic leg and the second outer magnetic leg, and located beside the first outer magnetic leg, wherein a first channel is formed between the first inner magnetic leg group and the first outer magnetic leg; and
a second inner magnetic leg group disposed between the first magnetic cover and the second magnetic cover, and between the first outer magnetic leg and the second outer magnetic leg, and located beside the second outer magnetic leg, wherein a second channel is formed between the second inner magnetic leg group and the first inner magnetic leg group, and a third channel is formed between the second inner magnetic leg group and the second outer magnetic leg; and
a winding assembly comprising four coupled windings, wherein the four coupled windings comprise four first terminals and four second terminals, wherein a first one of the four first terminals of the four coupled windings is located near a first lateral side of the magnetic core assembly and the first channel, a second one of the four first terminals of the four coupled windings is located near the first lateral side of the magnetic core assembly and the third channel, and the other two of the four first terminals of the four coupled windings are located near the first lateral side of the magnetic core assembly and the second channel, wherein a first one of the four second terminals of the four coupled windings is located near a second lateral side of the magnetic core assembly and the first channel, a second one of the four second terminals of the four coupled windings is located near the second lateral side of the magnetic core assembly and the third channel, and the other two of the four second terminals of the four coupled windings are located near the second lateral side of the magnetic core assembly and the second channel.

2. The magnetic device according to claim 1, wherein the first inner magnetic leg group comprises a first inner magnetic leg and a second inner magnetic leg, and the second inner magnetic leg group comprises a third inner magnetic leg and a fourth inner magnetic leg, wherein the first inner magnetic leg and the second inner magnetic leg are located near the first outer magnetic leg, the first inner magnetic leg is located near the first lateral side of the magnetic core assembly, and the second inner magnetic leg is located near the second lateral side of the magnetic core assembly, wherein the third inner magnetic leg and the fourth inner magnetic leg are located near the second outer magnetic leg, the third inner magnetic leg is located near the second lateral side of the magnetic core assembly, and the fourth inner magnetic leg is located near the first lateral side of the magnetic core assembly, wherein a fourth channel is formed between the first inner magnetic leg and the second inner magnetic leg, and the fourth channel is in communication with the first channel and the second channel, wherein a fifth channel is formed between the third inner magnetic leg and the fourth inner magnetic leg, and the fifth channel is in a communication with the second channel and the third channel.

3. The magnetic device according to claim 2, wherein a first part of the first channel is disposed between the first inner magnetic leg and the first outer magnetic leg, a second part of the first channel is disposed between the second inner magnetic leg and the first outer magnetic leg, a first part of the second channel is disposed between the first inner magnetic leg and the fourth inner magnetic leg, a second part of the second channel is disposed between the second inner magnetic leg and the third inner magnetic leg, a first part of the third channel is disposed between the fourth inner magnetic leg and the second outer magnetic leg, and a second part of the third channel is disposed between the third inner magnetic leg and the second outer magnetic leg, wherein the four coupled windings comprise:
a first secondary winding, wherein a first terminal of the first secondary winding is located near the first lateral side of the magnetic core assembly and the first part of the second channel, and a second terminal of the first secondary winding is located near the second lateral side of the magnetic core assembly and the second part of the first channel, wherein the first secondary winding is sequentially transferred through the first part of the second channel, the fourth channel and the second part of the first channel from the first terminal to the second terminal;
a second secondary winding, wherein a first terminal of the second secondary winding is located near the first lateral side of the magnetic core assembly and the first part of the first channel, and a second terminal of the second secondary winding is located near the second lateral side of the magnetic core assembly and the second part of the second channel, wherein the second secondary winding is sequentially transferred through the first part of the first channel, the fourth channel and the second part of the second channel from the first terminal to the second terminal, and the first secondary winding and the second secondary winding in the fourth channel are crossed with each other;
a third secondary winding, wherein a first terminal of the third secondary winding is located near the first lateral side of the magnetic core assembly and the first part of the third channel, and a second terminal of the third secondary winding is located near the second lateral side of the magnetic core assembly and the second part of the second channel, wherein the third secondary winding is sequentially transferred through the first part of the third channel, the fifth channel and the second part of the second channel from the first terminal to the second terminal; and
a fourth secondary winding, wherein a first terminal of the fourth secondary winding is located near the first lateral side of the magnetic core assembly and the first part of the second channel, and a second terminal of the fourth secondary winding is located near the second lateral side of the magnetic core assembly and the second part of the third channel, wherein the fourth secondary winding is sequentially transferred through the first part of the second channel, the fifth channel and the second part of the third channel from the first terminal to the second terminal, and the third secondary winding and the fourth secondary winding in the fifth channel are crossed with each other.

4. The magnetic device according to claim 3, wherein the winding assembly further comprises a primary winding assembly, wherein the first terminal of the primary winding assembly is located near the second side of the magnetic core assembly and the second part of the first channel, and a second terminal of the primary winding assembly is located near the second lateral side of the magnetic core assembly and the second part of the third channel, wherein the primary winding assembly is sequentially transferred through the second part of the first channel, the fourth channel, the fifth channel, the first part of the third channel, an outer side of the fourth inner magnetic leg, the first part of the first channel, the fourth channel, the fifth channel and the second part of the third channel from the first terminal to the second terminal, and at least two segments of the primary winding assembly in the fourth channel or the fifth channel are crossed with each other, wherein the primary winding assembly is wound around the first inner magnetic leg and the fourth inner magnetic leg from the first terminal to the second terminal along a first direction, and the primary winding assembly is wound around the second inner magnetic leg and the third inner magnetic leg from the first terminal to the second terminal along a second direction, wherein the first direction and the second direction are opposite.

5. The magnetic device according to claim 2, wherein a first part of the first channel is disposed between the first inner magnetic leg and the first outer magnetic leg, a second part of the first channel is disposed between the second inner magnetic leg and the first outer magnetic leg, a first part of the second channel is disposed between the first inner magnetic leg and the fourth inner magnetic leg, a second part of the second channel is disposed between the second inner magnetic leg and the third inner magnetic leg, a first part of the third channel is disposed between the fourth inner magnetic leg and the second outer magnetic leg, and a second part of the third channel is disposed between the third inner magnetic leg and the second outer magnetic leg, wherein the four coupled windings comprise:
a first secondary winding, wherein a first terminal of the first secondary winding is located near the first lateral side of the magnetic core assembly and the first part of the second channel, and a second terminal of the first secondary winding is located near the second lateral side of the magnetic core assembly and the second part of the first channel, wherein the first secondary winding is sequentially transferred through the first part of the second channel, the fourth channel and the second part of the first channel from the first terminal to the second terminal;
a second secondary winding, wherein a first terminal of the second secondary winding is located near the first lateral side of the magnetic core assembly and the first part of the first channel, and a second terminal of the second secondary winding is located near the second lateral side of the magnetic core assembly and the second part of the second channel, wherein the second secondary winding is sequentially transferred through the first part of the first channel, the fourth channel and the second part of the second channel from the first terminal to the second terminal, and the first secondary winding and the second secondary winding in the fourth channel are crossed with each other;
a third secondary winding, wherein a first terminal of the third secondary winding is located near the first lateral side of the magnetic core assembly and the first part of the second channel, and a second terminal of the third secondary winding is located near the second lateral side of the magnetic core assembly and the second part of the third channel, wherein the third secondary winding is sequentially transferred through the first part of the second channel, the fifth channel and the second part of the third channel from the first terminal to the second terminal; and
a fourth secondary winding, wherein a first terminal of the fourth secondary winding is located near the first lateral side of the magnetic core assembly and the first part of the third channel, and a second terminal of the fourth secondary winding is located near the second lateral side of the magnetic core assembly and the second part of the second channel, wherein the fourth secondary winding is sequentially transferred through the first part of the third channel, the fifth channel and the second part of the second channel from the first terminal to the second terminal, and the third secondary winding and the fourth secondary winding in the fifth channel are crossed with each other.

6. The magnetic device according to claim 5, wherein the winding assembly further comprises:
a first primary winding, wherein a first terminal of the first primary winding is located near the first lateral side of the magnetic core assembly and the first part of the first channel, and a second terminal of the first primary winding is located near the first lateral side of the magnetic core assembly and the first part of the second channel, wherein the first primary winding is sequentially transferred through the first part of the first channel, the fourth channel, the second part of the second channel, an outer side of the second inner magnetic leg, the second part of the first channel, the fourth channel and the first part of the second channel from the first terminal to the second terminal; and
a second primary winding, wherein a first terminal of the second primary winding is located near the first lateral side of the magnetic core assembly and the first part of the third channel, and a second terminal of the second primary winding is located near the first lateral side of the magnetic core assembly and the first part of the second channel, wherein the second primary winding is sequentially transferred through the first part of the third channel, the fifth channel, the second part of the second channel, an outer side of the third inner magnetic leg, the second part of the third channel, the fifth channel and the first part of the second channel from the first terminal to the second terminal,
wherein the first primary winding is wound around the first inner magnetic leg from the first terminal to the second terminal along a first direction, the first primary winding is wound around the second inner magnetic leg from the first terminal to the second terminal along a second direction, the second primary winding is wound around the third inner magnetic leg from the first terminal to the second terminal along the first direction, and the fourth primary winding is wound around the fourth inner magnetic leg from the first terminal to the second terminal along the second direction, wherein the first direction and the second direction are opposite.

7. The magnetic device according to claim 6, wherein the first primary winding and the second primary winding are connected with each other in series, wherein the first terminal of the second primary winding is connected with the second terminal of the first primary winding.

8. The magnetic device according to claim 6, wherein the first primary winding and the second primary winding are connected with each other in parallel, wherein the first terminal of the second primary winding is connected with the first terminal of the first primary winding, and the second terminal of the second primary winding is connected with the second terminal of the first primary winding.

9. The magnetic device according to claim 1, wherein the first inner magnetic leg group and the second inner magnetic leg group comprises a single inner leg, respectively.

10. The magnetic device according to claim 9, wherein the four coupled windings comprise a first secondary winding, a second secondary winding, a third secondary winding and a fourth secondary winding, wherein a first terminal of the first secondary winding is located beside the first lateral side and the second channel of the magnetic core assembly, a second terminal of the first secondary winding is located beside the second lateral side and the second channel of the magnetic core assembly, and the first secondary winding is transferred through the second channel, wherein a first terminal of the second secondary winding is located beside the first lateral side and the first channel of the magnetic core assembly, a second terminal of the second secondary winding is located beside the second lateral side and the first channel of the magnetic core assembly, and the second secondary winding is transferred through the first channel, wherein a first terminal of the third secondary winding is located beside the first lateral side and the second channel of the magnetic core assembly, a second terminal of the third secondary winding is located beside the second lateral side and the second channel of the magnetic core assembly, and the third secondary winding is transferred through the second channel, wherein a first terminal of the fourth secondary winding is located beside the first lateral side and the third channel of the magnetic core assembly, a second terminal of the fourth secondary winding is located beside the second lateral side and the third channel of the magnetic core assembly, and the fourth secondary winding is transferred through the third channel.

11. The magnetic device according to claim 10, wherein the winding assembly comprises a primary winding assembly, a first terminal and a second terminal of the primary winding assembly are located beside one side of the first inner magnetic leg group near to the first lateral side of the magnetic core assembly, the primary winding assembly is wound around the first inner magnetic leg group and the second inner magnetic leg group form the first terminal to the second terminal, and the direction of winding portion of the primary winding assembly around the first inner magnetic leg group and the direction of winding the other portion of the primary winding assembly around the second inner magnetic leg group are opposed, wherein the primary winding assembly from the first terminal to the second terminal is sequentially transferred through the first channel, one side of the first inner magnetic leg group near to the second lateral side of the magnetic core assembly, the second channel, one side of the second inner magnetic leg group near to the first lateral side of the magnetic core assembly, the third channel, one side of the second inner magnetic leg group near to the second lateral side of the magnetic core assembly and the second channel, wherein at least two segments of the primary winding assembly in the second channel are crossed with each other, the portion of the primary winding assembly is wound around the first inner magnetic leg group, and the other portion of the primary winding assembly is wound around the second inner magnetic leg group.

12. The magnetic device according to claim 2, wherein the first inner magnetic leg, the second inner magnetic leg, the third inner magnetic leg and the fourth inner magnetic leg of the magnetic core assembly are made of a low magnetic resistance material, and a rest of the magnetic core assembly is made of a high magnetic resistance material.

13. The magnetic device according to claim 12, wherein the low magnetic resistance material is ferrite without an air gap, and the high magnetic resistance material is ferrite with a centralized air gap or iron powder with a distributed air gap.

14. The magnetic device according to claim 2, wherein the first inner magnetic leg, the second inner magnetic leg, the third inner magnetic leg, the fourth inner magnetic leg, a region of the first magnetic cover between the first inner magnetic leg and the second inner magnetic leg, a region of the first magnetic cover between the third inner magnetic leg and the fourth inner magnetic leg, a region of the second magnetic cover between the first inner magnetic leg and the second inner magnetic leg and a region of the second magnetic cover between the third inner magnetic leg and the fourth inner magnetic leg are made of a low magnetic resistance material, and a rest of the magnetic core assembly is made of a high magnetic resistance material.

15. The magnetic device according to claim 14, wherein the low magnetic resistance material is ferrite without an air gap, and the high magnetic resistance material is ferrite with a centralized air gap or iron powder with a distributed air gap.

16. The magnetic device according to claim 9, wherein the magnetic device is an coupled inductor, wherein the four coupled windings includes a first coupled winding, a second coupled winding, a third coupled winding and a fourth coupled winding, wherein a first terminal of the first coupled winding is located beside the first lateral side and the first channel of the magnetic core assembly, a second terminal of the first coupled winding is located beside the second lateral side and the first channel of the magnetic core assembly, the first coupled winding is transferred through the first channel, wherein the first terminal of the second coupled winding is located beside the first lateral side and the second channel of the magnetic core assembly, a second terminal of the second coupled winding is located beside the second lateral side and the second channel of the magnetic core assembly, the second coupled winding is transferred through the second channel, wherein a first terminal of the third coupled winding is located beside the first lateral side and the third channel of the magnetic core assembly, a second terminal of the third coupled winding is located beside the second lateral side and the third channel, the third coupled winding is transferred through the third channel, wherein a first terminal of the fourth coupled winding is located beside the first lateral side and the second channel of the magnetic core assembly, a second terminal of the fourth coupled winding is located beside the second lateral side and the second channel of the magnetic core assembly, and the fourth coupled winding is transferred through the second channel.

17. The magnetic device according to claim 1, wherein the first end and the second end of the first magnetic cover are opposed to each other, the first end and the second end of the second magnetic cover are opposed to each other, the first lateral side and the second lateral side of the magnetic core assembly are opposed to each other, the first inner magnetic leg group is connected between the first magnetic cover and the second magnetic cover, and the second inner magnetic leg group is connected between the first magnetic cover and the second magnetic cover, wherein when DC currents flow through the four coupled windings along a same direction, first DC magnetic fluxes generated by two of the four coupled windings and applied to the first inner magnetic leg group are cancelled out, and second DC magnetic fluxes generated by the other two of the four coupled windings and applied to the second inner magnetic leg group are cancelled out.

18. An electronic device, comprising:
a circuit board comprising a first surface, a second surface and a plurality of openings, wherein the plurality of openings run through the circuit board;
a magnetic device comprising:
a magnetic core assembly comprising a first magnetic cover, a second magnetic cover, a first outer magnetic leg, a second outer magnetic leg, a first inner magnetic leg group and a second inner magnetic leg group, wherein the first magnetic cover and the second magnetic cover are opposed to each other, the first outer magnetic leg is disposed between a first end of the first magnetic cover and a first end of the second magnetic cover, and the second outer magnetic leg group is disposed between a second end of the first magnetic cover and a second end of the second magnetic cover, wherein the first inner magnetic leg group is disposed between the first magnetic cover and the second magnetic cover, and between the first outer magnetic leg and the second outer magnetic leg and located beside the first outer magnetic leg, and the second inner magnetic leg is disposed between the first magnetic cover and the second magnetic cover, and between the first outer magnetic leg and the first second outer magnetic leg and located beside the second outer magnetic leg, wherein there is a first channel between the first inner magnetic leg group and the first outer magnetic leg, there is a second channel between the second inner magnetic leg group and the first inner magnetic leg group, and there is a third channel between the second inner magnetic leg group and the second outer magnetic leg; and
a winding assembly comprising four coupled windings, wherein the four coupled windings comprise four first terminals and four second terminals, wherein a first one of the four first terminals of the four coupled windings is located near a first lateral side of the magnetic core assembly and the first channel, a second one of the four first terminals of the four coupled windings is located near the first lateral side of the magnetic core assembly and the third channel, and the other two of the four first terminals of the four coupled windings are located near the first lateral side of the magnetic core assembly and the second channel, wherein a first one of the four second terminals of the four coupled windings is located near a second lateral side of the magnetic core assembly and the first channel, a second one of the four second terminals of the four coupled windings is located near the second lateral side of the magnetic core assembly and the third channel, and the other two of the four second terminals of the four coupled windings are located near the second lateral side of the magnetic core assembly and the second channel,
wherein the four coupled windings are disposed in the circuit board, the first magnetic cover is disposed on the first surface of the circuit board, and the second magnetic cover is disposed on the second surface of the circuit board, wherein the first outer magnetic leg, the second outer magnetic leg, the first inner magnetic leg group and the second inner magnetic leg group are penetrated through the corresponding one of the plurality of openings, respectively; and
at least one switch, wherein the at least one switch is electrically connected with the magnetic device through at least one trace in the circuit board.

19. The electronic device according to claim 18, wherein the first end and the second end of the first magnetic cover are opposed to each other, the first end and the second end of the second magnetic cover are opposed to each other, the first lateral side and the second lateral side of the magnetic core assembly are opposed to each other, the first inner magnetic leg group is connected between the first magnetic cover and the second magnetic cover, and the second inner magnetic leg group is connected between the first magnetic cover and the second magnetic cover, wherein when DC currents flow through the four coupled windings along a same direction, first DC magnetic fluxes generated by two of the four coupled windings and applied to the first inner magnetic leg group are cancelled out, and second DC magnetic fluxes generated by the other two of the four coupled windings and applied to the second inner magnetic leg group are cancelled out.
